(19) United States
(12) Patent Application Publication
(10) Pub. No.: US 2023/0100873 A1
(43) Pub. Date: Mar. 30, 2023

(54) MEMORY TAGGING AND TRACKING FOR OFFLOADED FUNCTIONS AND CALLED MODULES

(71) Applicant: Intel Corporation, Santa Clara, CA (US)

(72) Inventors: Enrico Galli, Beaverton, OR (US); Andrew S. Brown, Hillsboro, OR (US); Mingqiu Sun, Beaverton, OR (US); Petr Penzin, Beaverton, OR (US)

(73) Assignee: Intel Corporation, Santa Clara, CA (US)

(21) Appl. No.: 18/061,954

(22) Filed: Dec. 5, 2022

(51) Int. Cl. G06F 9/50; G06F 9/30; G06F 11/07

(52) U.S. Cl. CPC G06F 9/5016; G06F 9/3004; G06F 11/0772

(57) ABSTRACT

An apparatus includes a first processor to be communicatively coupled to a main memory having instructions stored therein. The first processor is to execute the instructions to assign a first tag to a plurality of granules in a first portion of memory allocated for an offloaded function invoked by a module running on a second processor, detect an exception raised for a tag check failure for a memory access operation based on a first memory address in the first portion of the memory, and update a modified address list to include information associated with the first memory address. The instructions are executed further to synchronize, based on the modified address list, a second portion of the memory allocated to the module with the first portion of the memory.

### BACKGROUND

Programming languages typically offer programmers the ability to design applications that pass control to other code to perform various tasks. A function, for example, is a set of code that performs a particular task and may be called by an application or, in some scenarios, by another function. When a function is called, the caller may pass one or more parameters to the function. Once the function completes the task, control is passed back to the caller and a return value or values may be returned to the caller. In other programming scenarios, an application may use computation offloading to transfer certain computational tasks to a separate processor such as an accelerator or an external platform. Computation offloading is often used for resource intensive tasks such as machine learning computations. Different programming languages may use different approaches for allocating memory, which can affect the efficiency of passing control to other code. Some programming languages, for example, require at least some memory synchronization when control is returned to a caller. Continued improvements to synchronizing or updating memory are desirable.

### BRIEF DESCRIPTION OF THE DRAWINGS

The present disclosure is best understood from the following detailed description when read with the accompanying figures.

FIG. 1 is a simplified illustration of an operating environment that includes a host in accordance with various embodiments.

FIGS. 2A and 2B illustrate examples of configurations of Web Assembly runtime environments and respective Web Assembly System Interfaces.

FIG. 3 is a simplified illustration of various types of WebAssembly modules in communication with different type systems and modules according to at least one embodiment.

FIG. 4 is a block diagram illustrating an example computing system implementing a memory tagging and tracking according to at least one embodiment.

FIG. 5 is a block diagram illustrating another example computing system implementing a memory tagging and tracking according to at least one embodiment.

FIG. 6 is an illustration providing a visual representation of an example scenario of memory tagging and tracking an offloaded function according to at least one embodiment.

FIG. 7 is a flow diagram of an example process associated with memory tagging and tracking for an offloaded function according to at least one embodiment.

FIG. 8 is a flow diagram of an example process associated with handling exceptions based on a failed tag check for an offloaded function according to at least one embodiment.

FIG. 9 is a flow diagram of an example process associated with synchronizing memory of an offloaded function with a caller module according to at least one embodiment.

FIG. 10 is a block diagram illustrating an example computing system implementing memory tagging and tracking for a callee WebAssembly module according to at least one embodiment.

FIG. 11 is a block diagram illustrating another example computing environment implementing memory tagging and tracking for a callee WebAssembly module according to at least one embodiment.

FIG. 12 is a flow diagram of an example process associated with memory tagging and tracking for a callee module according to at least one embodiment.

FIG. 13 is a flow diagram of an example process associated with memory tagging and tracking for a callee module according to at least one embodiment.

FIG. 14 is a flow diagram of an example process for handling exceptions based on a failed tag check for a callee module according to at least one embodiment.

FIG. 15 is a flow diagram of an example process for synchronizing buffers of a callee module to a caller module according to at least one embodiment.

FIG. 16 is a block diagram of an example compute node that may include any of the embodiments disclosed herein.

FIG. 17 illustrates a multi-processor environment in which embodiments may be implemented.

FIG. 18 is a block diagram of an example processor unit to execute computer-executable instructions as part of implementing technologies described herein.

### DETAILED DESCRIPTION

The present disclosure provides various possible embodiments, or examples, of systems, methods, apparatuses, architectures, and machine readable media for memory tagging and tracking for offloaded functions and called modules. Embodiments disclosed herein utilize memory tagging hardware technology to track memory that is modified by callee code and to synchronize the caller's memory to memory that is modified by the callee. For function calls within a process (e.g., module call within a component), disjointed memories of the process may be synchronized by tracking each memory modification by the callee and then updating each modified memory address or interval (e.g., memory range). For calls involving separate memories (e.g., component-to-component), memory tagging may be used to determine whether synchronization of a buffer passed by the caller is needed or not. For example, synchronization may be needed if modifications are made by the callee, whereas synchronization may not be needed if no modifications are made by the callee.

Embodiments described herein could be applied to a variety of different programming languages but may provide particular advantages for programming languages that typically communicate large amounts of data when invoking offloaded functions or called functions. For example, WebAssembly was recently developed as a low-level programming language having a portable binary code format that is independent of host architecture. WebAssembly is capable of running with near native performance and can be a compilation target for other low-level languages. One feature of WebAssembly is the use of a linear memory buffer, which is an expandable array of bytes and is managed by the host runtime. A buffer can be used to pass values back and forth between a caller and a callee with separate memories. Memory tagging can be used to tag portions of the linear memory buffer that are modified by a callee and to enable synchronization of the modified portions to the caller's linear memory buffer when control is passed back to the caller.

For purposes of illustrating embodiments of memory tagging and tracking for offloaded functions and called modules, it is helpful to understand the characteristics of computation offloading, component interactions, and a software language, such as WebAssembly, that utilizes a linear memory buffer. Accordingly, the following introductory information provides context for understanding the embodiments disclosed herein.

Increased Web usage has led to increasingly sophisticated and software-demanding Web applications. This increased demand has highlighted deficiencies in the efficiency of JavaScript, the current software language commonly used for Web applications. WebAssembly (also sometimes referred to as WebAsm or WASM) is a collaboratively developed portable low-level bytecode designed to improve upon the deficiencies of JavaScript. WebAssembly is architecture independent (i.e., it is language-independent, hardware-independent, and platform-independent), and suitable for both Web use cases and non-Web use cases. WebAssembly computation is based on a stack machine with an implicit operand stack.

Because of the architecture-independence of JavaScript and WebAssembly, in practice, a host receiving a JavaScript file or WebAssembly program may employ a respective just-in-time (JIT) compilation module to translate or JIT software compile the JavaScript file or WebAssembly program into native machine code that is specifically optimized for the host architecture (e.g., a host processing unit, such as, a complex instruction set computer/architecture (CISC) or a reduced instruction set computer/architecture (RISC) that has a specific machine architecture and language). Often, the JIT compile operations are done in host software using host-specific libraries. In other scenarios, the portable binary code format of WebAssembly can be compiled ahead of time (AOT) and/or can be interpreted. Additionally, WebAssembly, is capable of running with near native performance and can be a compilation target for other low-level languages in addition to higher-level languages.

A WebAssembly component model defines how modules may be composed within an application or library. The component model provides mechanisms for dynamically linking modules into components, and components into higher-level components. The component model also provides interface types that define a module interface for high level data types (e.g., records, arrays, etc.). Interface types are not concrete (or native) types on which operations are performed. Rather, interface types provide an abstract representation of data that may be generated based on one native type and that may be consumed based on another (or the same) native type. Interface types enable representation of data based on complicated native types. WASM interface types enable WASM module-to-module communication (including inter-component communication). In other embodiments, a universal interface type could enable module-to-module communication where one module runs in its native runtime, module-to-system communication, and system-to-module communication. In yet another embodiment, an intra-component interface type could enable WASM module-to-module communications within a component, where communicating WASM modules are linked or instantiated.

Transformations of data from a native type to an interface type can be achieved by interface adapters. Consider a caller module compiled into WASM target code from a first software language that calls a second module compiled into WASM target code from a second software language. In this scenario, an “uplifting” adapter can be used to convert return data generated by the callee module based on a native type of the native software language of the callee module (e.g., second software language) into return data having an appropriate interface type. The “uplifted” return data (having the appropriate interface type) can be converted by a “lowering” adapter into return data having a native type of the software language of the caller module (e.g., first software language). The resulting “lowered” return data may then be consumed by the caller module. Additionally, an uplifting adapter may be used to convert a parameter generated by the caller module based on a native type of the software language of the caller module into a parameter having an appropriate interface type. The “uplifted” parameter (having the appropriate interface type) can be converted by a lowering adapter into a parameter having a native type of the software language of the callee module. An adapter may include a sequence of instructions to perform the desired conversions.

Another feature of WebAssembly is a linear memory model. The memory of a WASM program is represented as a contiguous array of uninterrupted bytes that is dynamically expandable and may be referred to as a ‘linear memory buffer’ or ‘WASM buffer’ or ‘WASM memory buffer.’ Generally, a buffer may be embodied as a range of memory addresses for storing data. WASM memory instructions can be used by the module to store, read, and/or modify the bytes in a linear memory buffer. The targeted bytes to be accessed can be identified based on an offset relative to the start of the linear memory buffer. The size of the linear memory buffer is always known and, therefore, the runtime can determine whether any given memory access is outside the boundaries of the allocated memory. Thus, WASM modules cannot access memory outside of the allocated memory without explicit access provided to the out-of-bounds memory. Additionally, the linear memory buffer is disjoint from the code space, the execution stack, and the data structures of the stack-based machine. Accordingly, corruption of the execution environment and other unsafe behavior can be prevented and process isolation can be achieved.

Although WebAssembly's linear memory buffer provides safety improvements over other programming languages, certain scenarios can result in inefficiencies and thus, can impose a performance overhead on WASM code. For example, it is well known that memory accesses can affect system performance. With WASM memory, a linear memory buffer may be used when a callee (e.g., a function, module, etc.) is invoked by a caller (e.g., an application, module, component, etc.). Such calls can include, for example, a computation offload in which a portion of code known as a ‘kernel function’ (also referred to herein as ‘offloaded function’) is offloaded to a separate device accessing separate memory. In another example, a linear memory buffer may be passed from a caller WASM module to a callee WASM module. In both scenarios, synchronizing memory of the caller with separate memory accessed by the callee may require significant, and sometimes unnecessary, memory accesses. Such accesses can negatively impact memory system performance.

Provided embodiments propose technical solutions for the above-described inefficiencies in the form of systems and methods for memory tagging, tracking, and synchronization for offloaded functions and called modules for a plurality of architectures. Memory tagging is a technique that mitigates the risk of memory safety bugs in memory unsafe programming languages such as C and C++, for example. Memory tagging involves tags, which are values associated with regions of application memory. At least some memory tagging schemes require setting a memory tag in a tag table for every granule of allocated data (e.g., 8 bytes, 16 bytes, 32 bytes or more), where a granule corresponds to the tagging granularity. A tag may be 4 bits, 5 bits, 6 bits, 7 bits, 8 bits, or any other number of bits that allows a sufficient number of different tag values to be used for tagging memory and that is small enough to be encoded in unused bits of a pointer. Pointers to the memory can be encoded with pointer tags that correspond to the memory tags. Memory tags are matched to the pointer tags per granule of data accessed from memory using the pointers to determine whether the memory being accessed is allocated to the pointer. A mismatch between the memory tag and the pointer tag can result in an exception notification in the process (e.g., in a program, application, function, module, etc.).

In one embodiment of using a memory tagging technique to track memory modifications, memory tagging is applied to memory accessed by a callee (e.g., a kernel function) that has been offloaded by a caller (e.g., a WASM module). The callee memory is initially tagged with an allocation tag, which is a value indicating that the particular granule has been allocated but not modified by the callee. The callee maintains a data structure containing memory addresses, memory address ranges, or other memory information (e.g., offsets, offset ranges, etc.) indicating locations in the callee memory that have been modified by the callee. The data structure is updated by the callee in response to memory tag failure exceptions that occur when data in the callee memory is modified. The data structure indicates memory addresses in the callee memory that need to be synchronized to (e.g., copied to) caller memory when the callee finishes executing. In addition, when data in a particular memory location (e.g., memory address or memory address range) in the callee memory is modified, granules in the memory location may be tagged (e.g., marked) with the value of the pointer tag encoded in the pointer used to access the memory address associated with the granules. Marking the granules associated with the memory address can include updating an appropriate entry or entries in a tag table mapped to the modified callee memory address or range of addresses with the value of the pointer tag encoded in the pointer used to access the memory address.

In another example of using a memory tagging technique to track memory modifications, memory tagging is applied to memory buffer of a caller module (e.g., caller WASM buffer of a caller WASM module) that is passed from the caller module to a callee module (e.g., callee WASM buffer of a callee WASM module). The data from a caller buffer (or “source buffer”) in memory allocated to the caller module is received by the callee module. The received data can be stored in a callee buffer (or “destination buffer”) in memory allocated to the callee module. The callee buffer may contain a write-back flag that can be set during the execution of the callee module if the callee module modifies data in the callee buffer. If the write-back flag is set when the callee module completes execution, this indicates that the callee buffer has been modified and, therefore, is to be copied to the caller buffer when the execution of the callee is finished. If the callee module does not modify the data in the callee buffer during the callee module's execution, then copying data from the callee buffer to the caller buffer can be avoided. Thus, both embodiments prevent unnecessary memory accesses and accordingly, can minimize inefficiencies. Furthermore, other desirable features and characteristics of the system and method will become apparent from the subsequent detailed description and the appended claims, taken in conjunction with the accompanying drawings and the preceding background.

The terms “component,” “module,” “functional block,” “block,” “system,” and “engine” may be used herein, with functionality attributed to them. As one with skill in the art will appreciate, in various embodiments, the functionality of each of the module/blocks/systems/engines described herein can individually or collectively be achieved in various ways; such as, via an algorithm implemented in software and executed by a processor unit (e.g., a CPU, complex instruction set computer (CISC) device, a reduced instruction set computer (RISC), compute node, graphics processing unit (GPU), infrastructure processing unit (IPU), vision processing unit (VPU), deep learning processor (DLP), inference accelerators, etc.), processing system, as discrete logic or circuitry, as an application specific integrated circuit, as a field programmable gate array, etc., or a combination thereof. The approaches and methodologies presented herein can be utilized in various computer-based environments (including but not limited to virtual machines, web servers, and stand-alone computers), edge computing environments, network environments, and/or database system environments.

As used herein, the terms “operating,” “executing,” “running,” and variations thereof as they pertain to software or firmware in relation to a processor, processing unit, compute node, system, device, platform, or resource, are used interchangeably and can refer to software or firmware stored in one or more computer-readable storage media accessible by the system, device, platform or resource, even though the software or firmware instructions are not actively being executed by the system, device, platform, or resource.

As used herein, the term “circuitry” can comprise, singly or in any combination, non-programmable (hardwired) circuitry, programmable circuitry such as processor units, state machine circuitry, and/or firmware that stores instructions executable by the programmable circuitry.

Some embodiments may have some, all, or none of the features described for other embodiments. Unless expressly stated to the contrary, the adjective terms “first,” “second,” “third,” and the like describe a common object and indicate different instances of like objects being referred to. Such adjectives do not imply objects so described must be in a given sequence, either temporally or spatially, in ranking, order, importance, hierarchy, or any other manner.

Reference is now made to the drawings, which are not necessarily drawn to scale, wherein similar or same numbers may be used to designate same or similar parts in different figures. The use of similar or same numbers in different figures does not mean all figures including similar or same numbers constitute a single or same embodiment. Like numerals having different letter suffixes may represent different instances of similar components. Elements described as “connected” may be in direct physical or electrical contact with each other, whereas elements described as “coupled” may co-operate or interact with each other, but they may or may not be in direct physical or electrical contact. The drawings illustrate generally, by way of example, but not by way of limitation, various embodiments discussed in the present document.

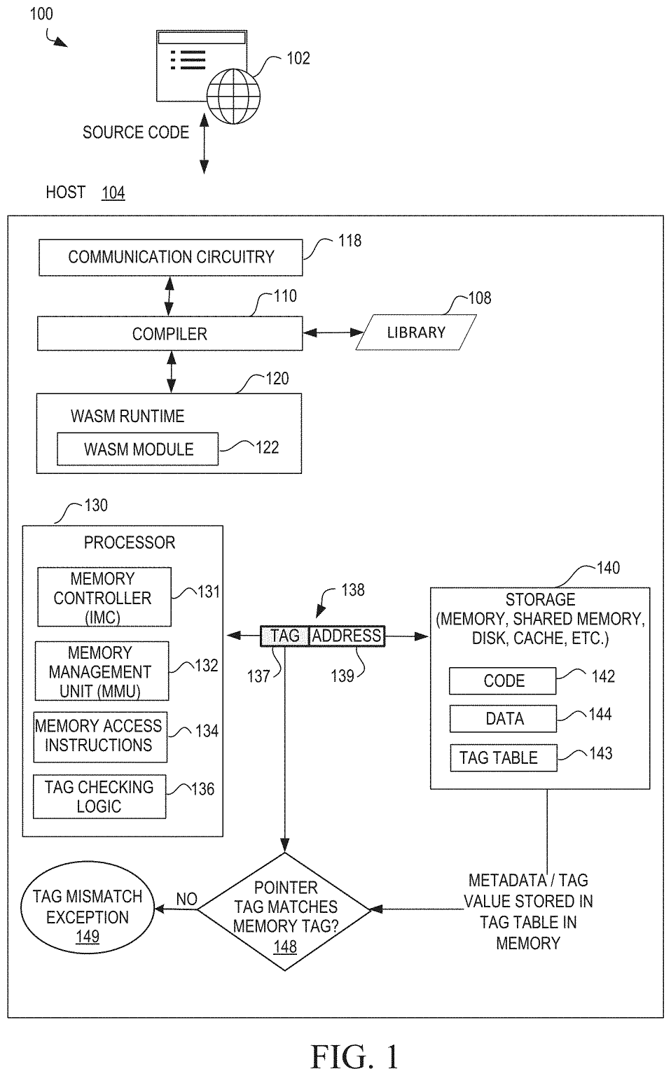

Turning now to FIG. 1, an example operating environment 100 includes a simplified illustration of a host 104 configured to receive source code (e.g., software instructions), run a browser, parse a web page, and run other user applications. The host 104 is in operational communication via communication circuitry 118 with the source 102 of a JavaScript file or WASM intermediate representation (WASM_IR). The host 104, via the communication circuitry 118 perform CISC instruction monitoring.

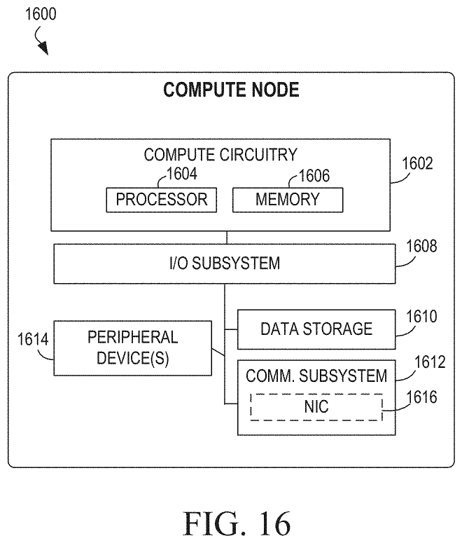

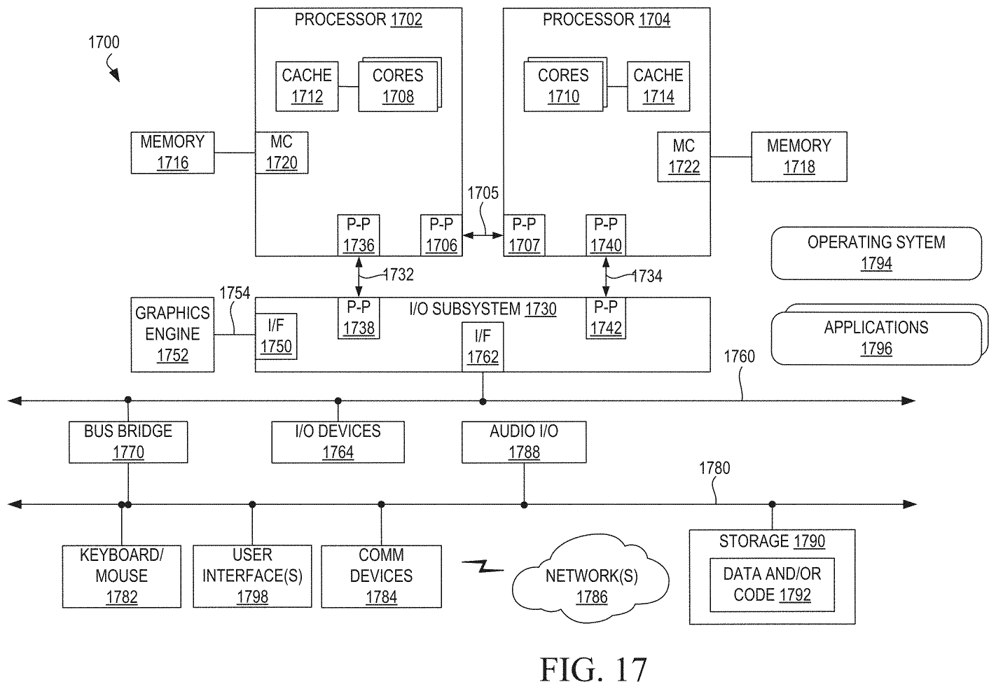

In practice, the source 102 may be one of a plurality of sources that each independently may transmit a JavaScript file or a WASM intermediate representation (WASM_IR) to the host 104. A WASM_IR is code used by a complier (e.g., compiler 110) to represent source code for higher-level languages (e.g., C, C++, Rush, Python, Go, etc.). As described herein, the host 104 relies on at least one complex instruction set CPU, indicated generally with processor unit 106, and together they embody a language and hardware architecture. The host 104 includes at least one storage unit, indicated generally with memory 116. As may be appreciated, in practice, the host 104 may be a complex computer node or computer processing system, and may include or be integrated with many more components and peripheral devices (see, for example, FIG. 16, compute node 1600, and FIG. 17, computing system 1700).

In a non-limiting example, the host 104 software comprises x86 instructions and the host 104 is configured to run a browser and perform x86 instruction monitoring. The host 104 architecture includes or is upgraded to include new compiler 110. Compiler 110 may be a JIT compiler in one example, which can be realized as hardware (circuitry) or an algorithm or set of rules embodied in software (e.g., stored in the memory 116) and executed by the processor 106. In one example, compiler 110 manages JIT compile operations for the host 104. In other embodiments, compiler 110 may be an AOT compiler. In yet further embodiments, an interpreter may be used instead of, or in addition to, compiler 110. In some scenarios, the source code may be compiled ahead of time on another host and communicated to host 104 via communication circuitry 118, for example. In yet other embodiments, the source code may be compiled ahead of time on another system and the compiled binary may be communicated via one or more networks, local links, or hardware devices (e.g., universal serial bus, etc.).

Compiler 110 is depicted as a separate functional block or module for discussion; however, in practice, compiler 110 logic may be integrated with the host processor 130 as software, hardware, or a combination thereof. Accordingly, compiler 110 may be updated during updates to the host 104 software. Compiler 110 executes a compile operation, and in doing so, compiler 110 references the host library 108. The host specific library 108 is configured with microcode (also referred to as machine code) instructions that are native to the host 104 architecture, so that the compile operation effectively translates incoming source code into native machine code.

In some scenarios, the native machine code generated by compiler 110 may be embodied as a WASM module 122. When embedded into a host application (e.g., browser, user code), WebAssembly runtime 120 may be embodied as a low level stack-based virtual machine that runs WASM programs (e.g., components, modules, components with modules, etc.), such as WASM module 122, for example. Standalone WASM runtime environments can be designed to manage interactions between the stack-based virtual machine (VM) that runs WASM programs and the environment in which the stack-based VM exists. A WASM runtime allows a WASM executable to be obtained by a VM upon instantiation of the VM. The WASM runtime also facilitates invocation of functions and passing of parameters and return values. A WASM buffer may be used to pass memory to be accessed by an invoked function.

Storage 140 can include any suitable memory device(s) to achieve the hardware memory tagging and tracking embodiments described herein. For example, storage 140 can include any volatile or non-volatile memory device including, without limitation, magnetic media (e.g., one or more tape drives), optical media, random access memory (RAM), dynamic random access memory (DRAM), read-only memory (ROM), flash memory, removable media, or any other suitable local or remote memory component or components. Memory devices may also include cache that is near the processor (e.g., level 2 and level 3 between the processor and RAM/DRAM). Other cache (e.g., level 1 (L1)) may be integrated with the processor 130. Memory devices store any suitable data 144 (e.g., variables, parameters, passed parameters, passed return values, memory access permissions, etc.) that is used by one or more processors 130 of host 104. Memory devices also store code 142 utilized by other elements of host 104, including software embedded in a computer readable medium, and/or encoded logic incorporated in hardware or otherwise stored (e.g., firmware). At least some code 142 (e.g., instructions, WASM module 122) may be executed by the processors 130 of host 104 and/or other processing elements in the same host 104 or different hosts of operating environment 100 to provide functionality associated with operating environment 100.

In one or more embodiments, a memory management unit (MMU) 132 of processor 130 can manage linear (virtual) memory for processes (e.g., instances of WASM components and/or WASM modules and/or other software modules) running in host 104. As used herein, the term ‘linear memory’ is intended to mean a logical view of memory for a computing system (e.g., with one or more devices), a host, a compute node, a device, etc. Linear memory appears to an application program as a single contiguous address space. Linear addresses may be translated to physical addresses as needed using linear-to-physical page tables. Conversely, physical memory addresses can be translated to linear memory addresses as needed using physical-to-linear page tables. The MMU 132 is a hardware device that can perform the linear and physical address translations. It should be noted that, depending on the implementation, linear memory buffers for WASM modules may be allocated in linear memory of a computing system, host, compute node, device, etc.

A memory controller 131 may be provided to manage the flow of data being read from and being written to the host's main memory. The memory controller may be integrated in the processor 130 as an integrated memory controller (IMC) or may be separate hardware in communication with the processor 130.

Processor 130 may be embodied as one or more elements suitable to perform memory tagging and tracking for offloaded functions and called modules as described herein. Examples of processor 130 include, but are not limited to one more of complex instruction set computer (CISC) devices, reduced instruction set computers (RISC), central processing units (CPUs), compute nodes, graphics processing units (GPUs), infrastructure processing units (IPUs), vision processing units (VPUs), deep learning processors (DLPs), inference accelerators, processing systems, discrete logic or circuitry, application specific integrated circuit, field programmable gate arrays, etc., or any suitable combination thereof.

Processor 130 can execute memory access instructions 134 to perform memory operations such as reading, writing, storing, moving, etc. Memory access instructions 134 may be embodied as bytecode (e.g., WebAssembly, JavaScript, etc.) to be converted into specific machine instructions by a software interpreter (e.g., virtual machine), processor instructions (e.g., as part of the processor instruction set architecture), or microcode (e.g., instructions that are stored in read only memory and executed directly by the processor 130). In other embodiments, memory access instructions 134 may be embodied as programming code executed by a privileged system component such as an operating system of the host 104 (e.g., in software as an instruction set emulator).

In one or more embodiments, a tag table 143 may be created and stored in memory (e.g., storage 140) for a process associated with an application, component (e.g., WASM component), module (e.g., WASM module 122), and/or any user code to be executed. The tag table 143 may be stored separately from the allocated memory of the process. The tag table 143 may be configured to store tags assigned to each granule of memory allocated to the process. A pointer 138 to the allocated memory of the process may include an address portion 139 and a tag portion 137. The address portion 139 can contain a linear address (or an identifying portion of a linear address) in the allocated memory of a process. The tag portion 137 can contain a tag (e.g., a value) that is expected to match a tag assigned to the memory location referenced by the linear address in the pointer 138.

As depicted in FIG. 1, generally in a given process, upon execution of an instruction that includes a memory operation (e.g., memory access instructions 134), according to one embodiment, processor circuitry (e.g., 130) and/or a tag checking logic 136 compares at 148 the pointer tag included in the tag portion 137 of pointer 138 with a memory tag assigned to the memory address and stored in a tag table 143 (or any other suitable metadata storage) in memory. For a memory allocation, a memory tag is assigned to each granule in the allocation. A granule is a taggable area of memory and may be associated with one or more memory addresses. For example, a single granule may span the memory referenced by one or more memory addresses. A granule may be defined as different sizes in different architectures. For example, a granule may be 8 bytes, 16 bytes, 32 bytes, or more or less depending on the particular implementation and/or architecture. If the pointer tag value included in the tag portion 137 of pointer 138 matches (e.g., exact match, complementary, or otherwise corresponding to as determined by a particular implementation) the memory tag in the tag table 143 assigned to a granule associated with the memory address indicated in the address portion 139 of the pointer 138, and if any other metadata checks (e.g., memory access bounds checks) also succeed, then the processor 130 and/or the IMC 131 completes the requested memory operation in the 140. If the pointer tag value included in the tag portion 137 of pointer 138 fails to match the memory tag value stored in the tag table in memory, then an exception occurs and the tag checking logic 136 reports the exception 149 (e.g., error, fault) to the processor 130. As shown in FIG. 1, in one or more embodiments, when an exception occurs, in addition to reporting the exception, the tag table 143 is updated with the tag value in the tag portion 137 of pointer 138, as will be further explained herein.

Tag checking logic 136 may be embodied as part of memory controller 131 (integrated with or separate from the processor). In another example, tag checking logic 136 may be dedicated hardware component that is integrated with processor 130 or provided as a discrete hardware component separate from processor 130. In other implementations, tag checking logic 136 may be a partially hardware-assisted compiler-based tool.

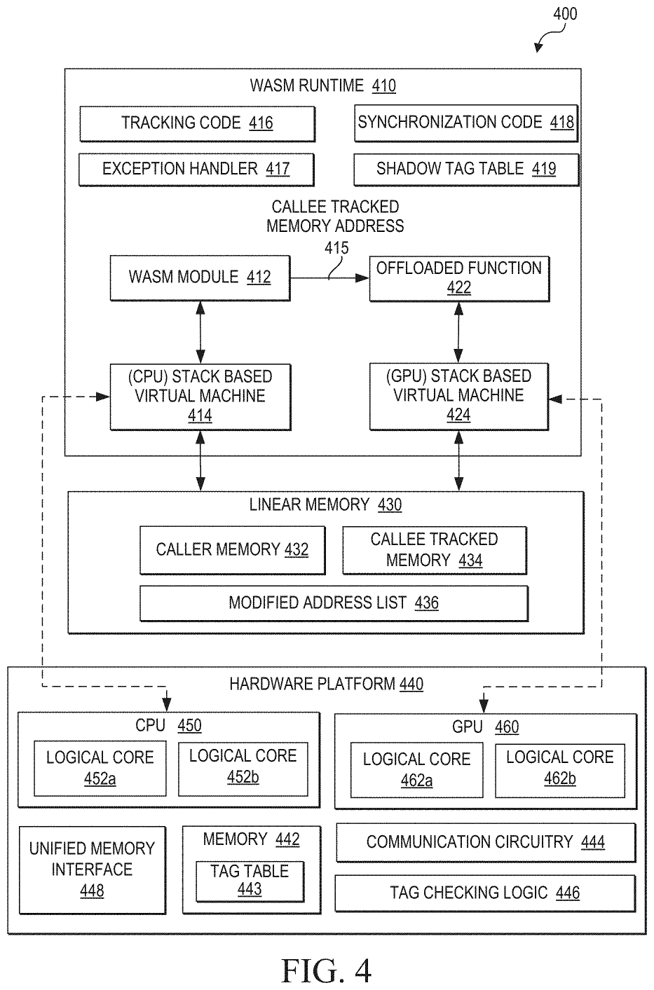

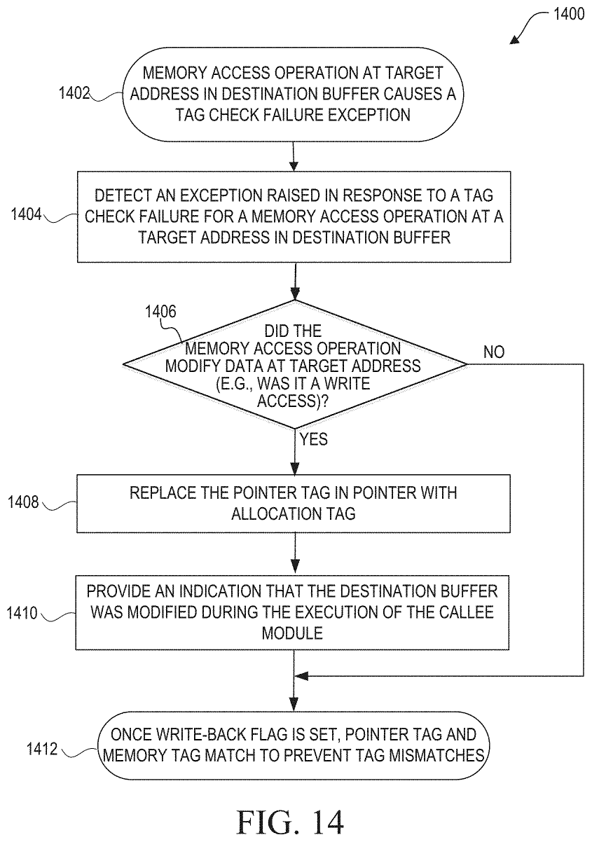

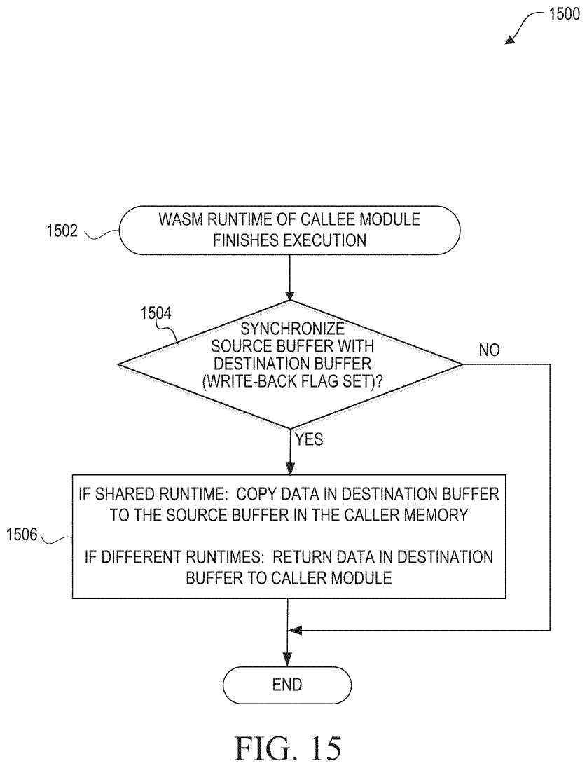

The functions and interactions of these system architectural blocks can be further described with a series of operations in a method. As used herein, a processor 130 or a computing system (e.g., FIGS. 4, 5, 10, 11) or a computer device, a compute node (FIG. 14) or a processing system (e.g., FIG. 15) referred to as being programmed to perform a method or process can be programmed to perform the method or process via software, hardware, firmware or combinations thereof.

As mentioned, WASM is a collaboratively developed portable low-level bytecode designed to improve upon the deficiencies of JavaScript. In various scenarios, WASM was developed with a component model in which code is organized in modules that have a shared-nothing inter-component invocation. A host 104, such as a virtual machine, container, or microservice, can be populated with multiple different WASM components (also referred to herein as WASM modules). The WASM modules interface using the shared-nothing interface, which enables fast instance-derived import calls. The shared-nothing interface enables software and hardware optimization via adaptors.

A WASM module contains definitions for functions, globals, tables, and memories. The definitions can be imported or exported. A module can define only one memory, that memory is a linear memory buffer that is mutable and may be shared. The code in a module is organized into functions. Functions can call each other, but functions cannot be nested. Instantiating a module can be provided by a JavaScript virtual machine or an operating system. An instance of a module corresponds to a dynamic representation of the module, its defined memory, and an execution stack. A WASM computation is initiated by invoking a function exported from the instance.

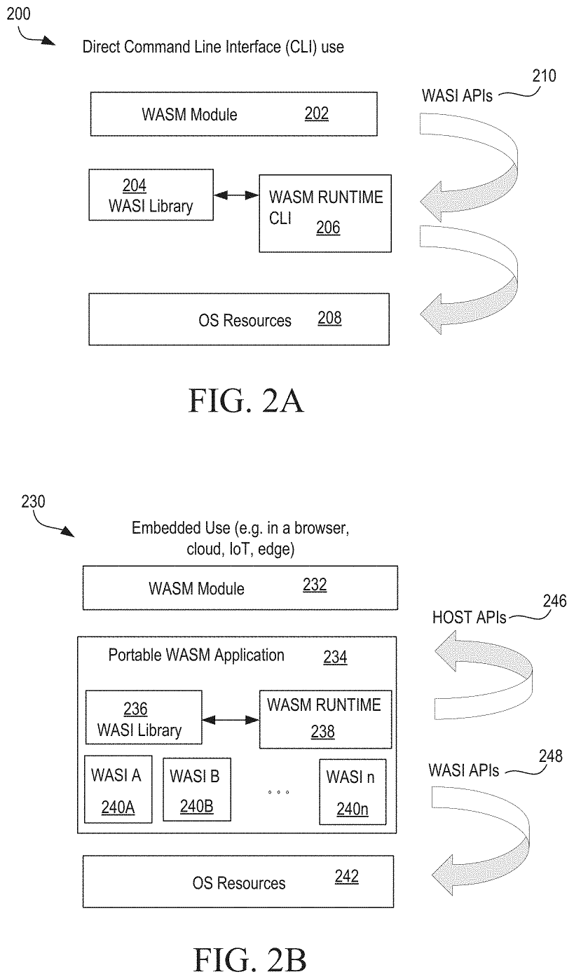

One example WASM runtime is “WASMTIME,” which is a jointly developed industry leading WebAssembly runtime; it includes a JIT compiler for WASM written in Rust. In various embodiments, a Web Assembly System Interface (WASI) that may be host specific (processor unit specific) is used to enable application specific protocols (e.g., for machine language, for machine learning, etc.) for communication and data sharing between the software environment running WASM (e.g., WASMTIME or other WASM runtime) and other host components. These concepts are illustrated in FIG. 2A. A first software environment 200 illustrates a WASM module 202 embodied as a direct command line interface (CLI). The WASI library 204 is referenced during WASM runtime CLI 206, and the operating system (OS) resources 208 of the host are utilized. A WASI application programming interface(s) 210 (“WASI API”) enables communication and data sharing between the components in the first software environment 200.

In FIG. 2B, a second software environment 230 illustrates a WASM module 232 in which WASM runtime and WASI are embedded in an application. In the embedded environment, a portable WASM application 234 includes the WASI library 236 that is referenced during WASM runtime 238. The portable WASM application 234 may be referred to as a user application. The second software environment 230 may employ a host API 246 for communication and data sharing within the WASM application 234 and employ multiple WASI implementations 240 for communication and data sharing between the portable WASM application 234 and the host OS resources 242 (indicated generally with WASI APIs 248). In various embodiments, different instances of WASI may be concurrently supported for communications with a host application, a native OS, bare metal, a Web polyfill, or similar. The portable WASM application 234 can transmit into the WASM runtime 238 model and encoding information, and the WASM runtime 238 may also reference models based thereon, such as, in a non-limiting example, a virtualized I/O machine learning (ML) model. The second software environment 230 may represent a standalone environment, such as, a standalone desktop, an Internet of Things (IOT) environment, a cloud application (e.g., a content delivery network (CDN), function as a service (FaaS), an envoy proxy, or the like). In other scenarios, the second software environment 230 may represent a resource constrained environment, such as in 10T, embedding, or the like.

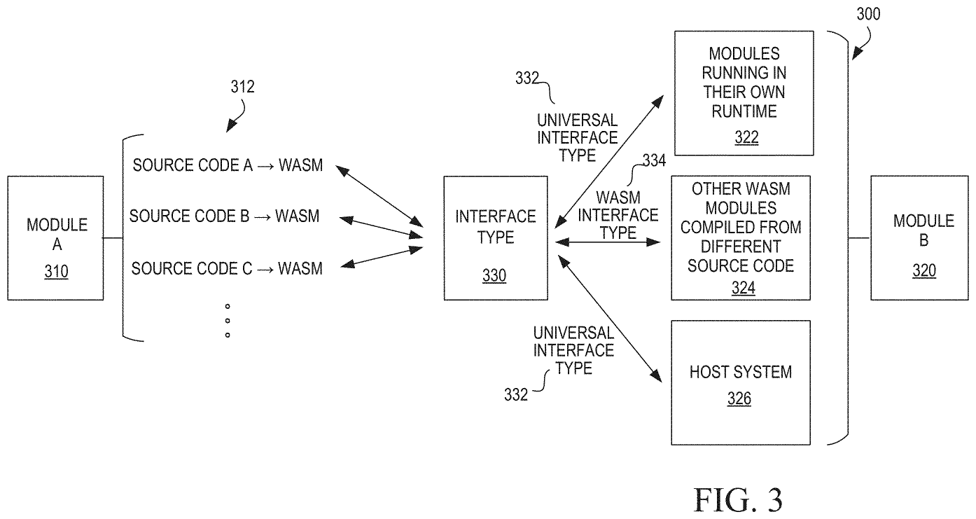

FIG. 3 is a simplified illustration of various WebAssembly modules in communication with different type systems and modules according to at least one embodiment. FIG. 3 illustrates example communications that are possible between WASM modules and different type modules and systems. As a compiler target, WASM provides a compilation target for a variety of software languages 312 (including low-level and higher-level software languages). The WASM compilation target, indicated by module A 310, can run on the Web or in other environments. Examples of software languages 312 (e.g., source code A, source code B, source code C, etc.) that can be compiled to WASM target code include, but are not limited to C#, C/C++, Rust, Python, and Go software languages.

Interface type technology is the glue that links WASM components together. Generally, FIG. 3 illustrates interface types 330 linking WASM modules that are written in different languages and compiled to WASM target code (e.g., WASM binary code). WASM interface types 334 enable communication between a WASM module A 310 and a WASM module B 320, which represents another WASM module written in the same (or different) source code 324 and compiled to WASM target code. Thus, module B 320 could be a WASM module compiled from a software language that is the same (or different) than the software language of the source code compiled to WASM module A 310. For example, a Rust module (e.g., module A 310) and a C++ module (e.g., module B 320) may communicate via interface types 330.

Adapter instructions can be used to convert language-native types of a sending module to an interface type, and to convert the interface type to a language-native type of a receiving module. The adapter instructions can use a WASM interface type 334 to perform the conversion from one WASM module (e.g., 310) to another WASM module (e.g., 320). For example, assume module A 310 is compiled from source code Rust into WASM target code, and calls module B 320, which is compiled from source code GO into WASM target code. In this scenario, module A 310 is a caller module, and module B 320 is a callee module. If the caller module 310 passes a Rust type parameter to the callee module 320, then a sequence of uplifting adapter instructions may be inserted in module A 310 to convert the Rust type parameter into an appropriate interface type parameter. Another sequence of lowering adapter instructions can be inserted in module B 320 to convert the interface type parameter into an appropriate Go type parameter that can be consumed by module B 320, the callee module. Often, multiple instructions are needed in the sequence of uplifting or lowering adapter instructions. In addition, the data passed between the modules may be copied and stored to linear memory buffers multiple times during the conversions and passing the data having different language-native types and interface type.

WASM interface types 334 are language agnostic and provide a specified mechanism for inter-component interactions of WASM. Interface types 330 may include basic, high-level data types that can be transmitted from module A 310 to module B 320, and vice-versa. Interface types 330 may not be concrete (or native) types on which operations are performed. Instead, interface types may represent the data being passed using basic types. For example, arrays may not be an interface type. Thus, when an array of integers [a, b, c] is passed between modules, uplifting adapter instructions could convert this into five integers: integer_array_type, array_length, a, b, c, where array_length=5. Thus, the five integers represent the interface type and contain all the information necessary for lowering adapter instructions to convert the five integers back into [a, b, c].

It should also be noted that, embodiments described herein, also allow for a universal interface type 332 that may be created to enable communication between a WASM module (e.g., module A 310) and many different type modules and systems. By way of example, a universal interface type 332 could be configured to enable communication between WASM module A 310 and a module 322 that is compiled based on its own native software language and that runs in its own runtime. By way of illustration, a language-native module may run in its own native runtime such as a Python module (which is not compiled to WASM target code) running in a Python runtime. In another example, a universal interface type 332 could be configured to enable communication between WASM module A 310 and a module that provides access to a host system 326. For example, module B 320 may be embodied as a WebAssembly system interface (WASI) that provides a system interface to an operating system or application programming interface (API) of a browser of a host system.

It should be further noted that embodiments described herein further allow for an intra-component interface type. An intra-component interface type may be created to enable communication between modules of a single component. By way of example, an intra-component interface type could be configured to enable communication between WASM modules compiled from different software languages and linked in the same component.

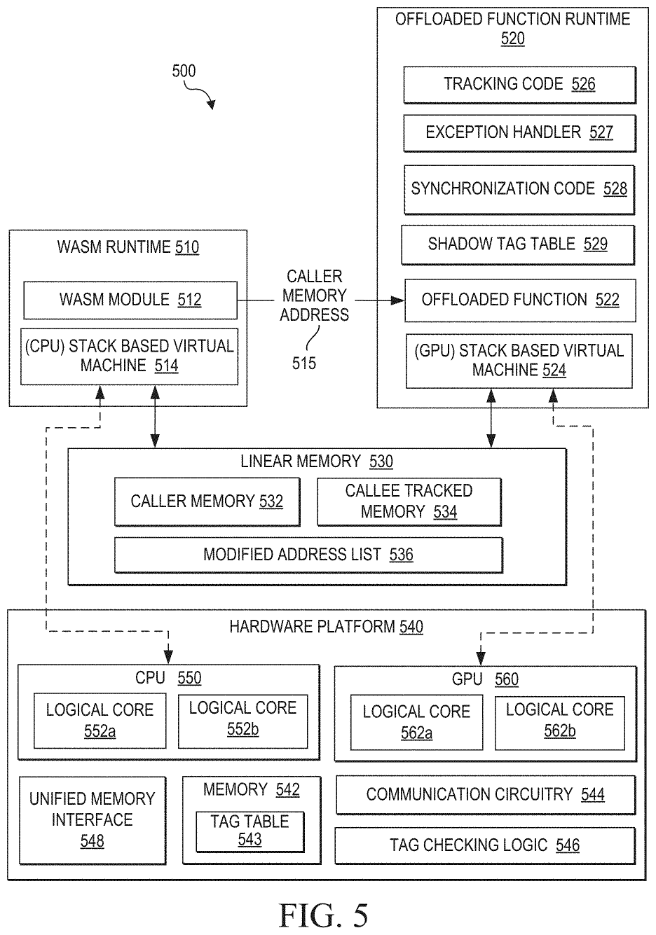

FIGS. 4 and 5 are block diagrams of example computing systems that illustrate embodiments utilizing memory tagging to track memory modifications and to synchronize memory contents in a heterogeneous computing environment involving multiple devices (e.g., CPU, GPU, etc.). The memory tagging, tracking, and synchronizing embodiments shown in FIGS. 4 and 5 involve computation offloading from one device (e.g., CPU) to another device (e.g., GPU). Computation offload is often a good strategy for achieving higher performance or more efficient execution for portions of certain workloads. For example, highly parallel loops, or matrix multiplication in a machine learning workload can often be executed more efficiently on GPU devices. A portion of code that is offloaded to another device is referred to as an ‘offloaded function’ or a ‘kernel function.’ With the main applications running on a CPU accessing the CPU's main memory, and a kernel function running on an accelerator (e.g., GPU) accessing the GPU's separate memory, synchronization is needed between the memories of the CPU and the GPU once the offloaded computation is finished.

Using memory tagging for tracking and synchronizing linear memory changes of kernel functions results in highly efficient operations. Memory tagging that is implemented in a portion of the address bits in a pointer can provide significant performance advantages by performing hardware-based pattern matching of addresses. Additionally, in at least some embodiments, special instructions could be used for bulk synchronization of a large set of addresses (or address ranges).

It should be noted that, for illustrative purposes, the components in the example computing systems illustrated in FIGS. 4-5 include WebAssembly modules and kernel functions that are offloaded from the WebAssembly modules. It should be apparent, however, the techniques described herein with respect the memory tagging and tracking for offloaded functions (e.g., kernel functions) could also be applied to components (or modules) compiled from software languages other than WebAssembly.

FIG. 4 is a block diagram illustrating an example computing system 400 implementing a memory tagging and tracking technique for offloaded kernel functions according to at least one embodiment. Computing system 400 includes a hardware platform 440 that supports linear memory 430, a WASM runtime 410, and stack based virtual machines (VMs) 414 and 424. The hardware platform 440 can include two or more physical processors, such as central processing unit (CPU) 450 and graphical processing unit (GPU) 460, memory 442, and communication circuitry 444. Computing system 400 is one example of host 104, including processors such as CPU 450 and GPU 460 (e.g., similar to processor 130), linear memory 430 (e.g., similar to linear memory of storage 140), WASM runtime 410 (e.g., similar to WASM runtime 120), memory 442 (e.g., similar to storage 140), and communication circuitry (e.g., similar to communication circuitry 118).

CPU 450 and GPU 460 are shown for illustration purposes only, and the physical processors of hardware platform 440 may include two or more processors that are capable of accessing the same memory (e.g., unified memory) and that allow a WASM module (e.g., 412) to run on one of the processors (e.g., CPU 450) and an offloaded function (e.g., 422) from the WASM module to run on another one of the processors (e.g., GPU 460). In some scenarios, the WASM module and its offloaded function may run on the same type of processors (e.g., both CPUs, both GPUs, etc.). By way of example, processors of hardware platform 440 could include, but are not limited to, CPUs, GPUs, VPUs, IPUs, DLPs, inference accelerators, other accelerators, or any suitable combination thereof. The processors of hardware platform 440 may each be single threaded or multithreaded and may each include a single core or multiple cores. In this example, CPU 450 includes logical core 452a and logical core 452b, which may correspond to threads of the same physical core of CPU 450 (e.g., for multithreading) or different physical cores of CPU 450. Similarly, GPU 460 includes logical cores 462a and 462b, which may correspond to threads of the same or different physical cores of GPU 460.

Generally, WASM virtualization obscures hardware characteristics of a computing system with a stack-based virtual machine that uses the WASM binary instruction format. In the example of computing system 400, stack based VMs 414 and 424 run on respective logical cores 452a and 462a that are on different physical cores of different physical processors CPU 450 and GPU 460, respectively. Therefore, stack based VM 414 abstracts low-level hardware interactions of CPU 450 and other components of hardware platform 440, and stack based VM 424 abstracts low-level hardware interactions of GPU 460 and other components of hardware platform 440. In some scenarios, a stack based VM (e.g., 414 or 424) may correspond to more than one physical core and/or more than one physical processor.

WASM runtime 410 manages, and coordinates resources for, WASM module 412 and offloaded function 422. More specifically, WASM runtime 410 facilitates interactions between the stack based virtual machines and hardware platform 440. For example, WASM runtime 410 and stack based VM 414 cooperate to execute WASM binary code of WASM module 412, with WASM runtime 410 facilitating interactions between the stack based VM 414 and CPU 450 and other hardware resources. Similarly, WASM runtime 410 and stack based VM 424 cooperate to execute WASM binary code of offloaded function 422, with WASM runtime 410 facilitating interactions between the stack based VM 424 and GPU 460 and other hardware resources. WASM runtime 410 may be implemented as any suitable WASM runtime (e.g., WASITIME, Wasmer, WebAssembly Micro Runtime (WAMR), Lucet, etc.) and programmed with additional functionality to enable the tagging, tracking, and synchronization described herein.

In at least one example, WASM module 412 (and corresponding WASM runtime 410) may be embedded in a browser or another guest user application. A guest user application can be embodied as a WASM component comprising one or more WASM modules such as WASM module 412 and managed by a WASM runtime.

Memory 442 may include any suitable memory or storage, including for example, storage 140 of FIG. 1. In one example, memory 442 may include unified memory to which both the WASM module 412 and offloaded function 422 of the WASM module have access. Unified memory is a memory technology in which the memory of a computing system is shared between the processing elements of the computing system. Accordingly, WASM module 412 and offloaded function 422 running on different stack based VMs 414 and 424 associated with different processors 450 and 460 of computing system 400 may each have access to unified memory, but different portions of the unified memory may be allocated to the WASM module and the offloaded function. The memory tagging, tracking, and synchronization technique for a kernel function offloaded from a WASM module, as illustrated in FIG. 4, offers efficient tracking and synchronization of the memories on different parts of the unified memory.

In computing system 400, linear memory 430 associated with WASM module 412 and offloaded function 422 may be mapped to unified memory in at least one embodiment. The unified memory may be embodied by memory 442, which is accessed via a unified memory interface 448. The linear memory 430 may be apportioned into caller memory 432 allocated to WASM module 412 and callee tracked memory 434 allocated to the offloaded function 422. In an implementation with a WASM module as shown in FIG. 4, caller memory 432 may be embodied as a WASM buffer for WASM module 412, and a caller tracked memory 434 may be embodied as a WASM buffer for the offloaded function 422. The linear memory 430 may be a single linear address space used by both the WASM module 412 and the offloaded function 422. In other implementations, the linear memory 430 may include two separate linear memories. In a scenario of separate linear memories, the WASM module 412 and offloaded function 422 may use the two separate linear memories, respectively, which are each mapped to the unified memory (e.g., memory 442 accessed via unified memory interface 448). In other implementations, WASM module 412 and offloaded function 422 may use respective contiguous physical address ranges in unified memory.

A modified address list 436 may be created and stored in the linear memory 430. In one example, the modified address list 436 may be created when offloaded function 422 is invoked, and may be stored in the callee tracked memory 434 or in any other allocated portion of the unified memory. The modified address list 436 may be used by the offloaded function 422 to store information representing linear addresses pointing to data in the callee tracked memory 434 that was modified by the offloaded function 422 during execution. The information may include linear memory addresses, linear memory offsets, ranges of linear memory addresses, ranges of linear memory offsets, or any other suitable information that conveys the location of the modified memory. The modified address list 436 (also referred to herein as ‘list’ or ‘address list’) may be implemented in any suitable data structure in which information can be incrementally added including, but not necessarily limited to a linear data structure, a non-linear data structure, a list data structure, a linked-list data structure, an array data structure, a table data structure, queue data structure, a stack data structure, a tree-based data structure, etc. In other implementations, physical memory addresses, offsets, and/or ranges may be used in modified address list 436.

Hardware platform 440 may include tag checking logic 446 (e.g., similar to tag checking logic 136 in host 104 of FIG. 1) and a tag table 443 (e.g., similar to tag table 143) to support memory tagging and tracking. Tag checking logic 446 may be implemented in CPU 450, in GPU 460, as a discrete component, integrated with another component having other functionality (e.g., memory controller) in hardware platform 440, or a suitable combination thereof. Furthermore, tag checking logic 446 may be implemented in firmware, software, or any combination of firmware, software, and/or hardware. In addition, tag table 443 may be stored in memory 442 and contain memory tags assigned to granules associated with memory addresses of callee tracked memory 434. During a memory access operation for a target address in callee tracked memory 434, tag checking logic 446 may compare a pointer tag in a pointer used to access the target address to a memory tag that is stored in tag table 443 and assigned to a granule associated with the target address. If the pointer tag and the memory tag do not match, then an exception is raised. Otherwise, if the tags match, an exception is not raised.

In one or more embodiments, WASM runtime 410 is configured to perform operations associated with tagging, tracking, and synchronization for WASM module 412 and offloaded function 422. In the example of FIG. 4, WASM runtime 410 includes tracking code 416 to enable tracking modifications of linear memory 430 allocated for the offloaded function 422 (e.g., callee tracked memory 434). WASM runtime 410 also includes an exception handler 417 to update the tag table and modified address list when a tag check failure (e.g., tag mismatch) occurs. WASM runtime 410 may further include synchronization code 418 to enable synchronization of the modified locations of the callee tracked memory 434 to corresponding locations of caller memory 432.

In at least one embodiment, the WASM module 412 requests the WASM runtime to allocate a block for the offloaded function that will be invoked. The WASM runtime returns, to the WASM module, a memory address of the new block. The memory address may be a base address of the new block (e.g., the callee tracked memory 434). Before the offloaded function 422 is initiated, the callee tracked memory 434 may be synchronized to contain the same data contained in the caller memory 432. In another embodiment, both the caller memory 432 and the callee tracked memory 434 may be initialized to a known state (e.g., all zeros, all ones). When invoking the offloaded function 422, WASM module 412 (or WASM runtime 410) can pass back the callee tracked memory address 415 to the offloaded function 422. This may be done so that the same offloaded function 422 can be used on different blocks of data or the same block can be passed to multiple functions. The callee tracked memory 434 may be synchronized (e.g., by synchronization code 418 of the runtime) to the caller memory 432 when the offloaded function finishes executing. The updated caller memory 432 may then be used by WASM module 412.

Tracking code 416 is configured to allocate (or cause the allocation of) callee tracked memory 434 for the offloaded function 422 when the offloaded function is invoked by WASM module 412. In one or more embodiments, each granule in callee tracked memory 434 is marked with a memory tag having a particular first value (e.g., representing a color blue) indicating that the granule to which the memory tag is assigned has been allocated but not modified by the offloaded function. A memory tag having the particular first value (e.g., representing the color blue) is also referred to herein as an ‘allocation tag’. Marking the callee tracked memory 434 can include storing the memory tag (e.g., the first value) in tag table 443 for each granule of the tracked memory. The tag table 443 may contain a memory tag entry for each granule of the callee tracked memory 434. A granule can be any number of bytes in memory that represents the tagging granularity. For example, a granule may be 4 bytes, 8 bytes, 16 bytes, 32 bytes, or more. Additionally, a granule may span one or more memory addresses (or offsets from a base address of the callee tracked memory).

A pointer to the callee tracked memory 434 is generated with a callee tracked memory address (e.g., a base address received from WASM module 412) and a pointer tag having a second value (e.g., representing the color green) that is different than the first value (e.g., representing the color blue) of the allocation tag assigned to each of the allocated granules in the callee tracked memory 434. A pointer tag having a second value (e.g., representing the color green) is also referred to herein as an ‘addressing tag’. A suitable number of bits in the pointer may be used to store an offset (e.g., relative to the base address) to enable the callee module to select any of the memory addresses in the callee tracked memory. Each time a memory access operation is performed on a target address in the callee tracked memory 434, a tag check is performed to determine whether the addressing tag in the pointer to the target address matches a memory tag stored in the tag table for the granule associated with the target address. If the tags do not match, then an exception is raised. When an exception is raised, this indicates that the memory access operation might be modifying the callee tracked memory 434 at a memory address that has not previously been modified.

The exception handler 417 is configured to handle exception processing when an exception is raised. In some scenarios, the exception handler 417 may be configured as part of WASM runtime 410. In other scenarios, the exception handler 417 may be separately provisioned, for example, based on the particular architecture of the computing system 400. If the memory access operation modifies the callee tracked memory 434 (e.g., via a write operation, etc.), then the exception handler 417 updates the memory tag assigned to the granule associated with the target address. The memory tag can be updated by replacing the allocation tag (e.g., first value representing the color blue) in the tag table 443 (e.g., via a shadow tag table) with the addressing tag (e.g., second value representing the color green) encoded in the pointer for the target address. If data in multiple granules is modified, then the respective allocation tags assigned to the multiple granules containing modified data can be updated in the tag table 443 with the addressing tag. The exception handler 417 (or other code, such as tracking code 416) updates the modified address list 436 with information indicating the target address of the memory operation. The information indicating the target address may include any suitable data such as a memory address, an offset to the target address, etc. In addition, in at least some embodiments, the information in the modified address list can indicate an address range (or offset range) that has been modified.

In at least some implementations, a shadow tag table 419 can be used by WASM runtime 410 to access (e.g., read, store) memory tags in memory 442 (e.g., main memory) used during execution of the offloaded function 422. Accordingly, tracking code 416 can access the shadow tag table 419 to update the allocation tag assigned to the granule associated with the target address.

Synchronization code 418 may also be part of WASM runtime 410 to perform synchronization operations to synchronize (e.g., update) the caller memory 432 with the modified portions of callee tracked memory 434. Synchronization code 418 may be configured to read the information in the modified address list to identify which addresses (or address ranges) in the callee tracked memory 434 were modified by the offloaded function 422. Addresses in the callee tracked memory 434 are referenced by a pointer containing a base address to the callee tracked memory 434 and an offset to the address or address range where modified data is located. The offsets for each of the modified addresses (or address ranges) where modified data is stored can be used by synchronization code 418 to identify the corresponding addresses (or address ranges) in the caller memory 432 that need to be updated. This can be achieved by using a pointer that contains a base address to the caller memory 432. The offsets into caller memory 432 map to the offsets into the callee tracked memory 434, based on respective pointers containing respective base addresses to the memories.

FIG. 5 is a block diagram illustrating another example computing system 500 implementing a memory tagging and tracking technique for offloaded kernel functions according to at least one embodiment. Computing system 500 is similar to computing system 400 of FIG. 4, with like names for like elements. For example, computing system 500 has a hardware platform 540 similar to hardware platform 440 of computing system 400. Hardware platform 540 includes two or more physical processors, such as central processing unit (CPU) 550 and graphical processing unit (GPU) 560, memory 542, and communication circuitry 544, which are similar to CPU 450, GPU 460, memory 442, and communication circuitry 444, respectively. In the example of FIG. 5, CPU 550 includes two logical cores 552a and 552b, and GPU 560 includes two logical cores 562a and 562b. In addition, a tag table 543 is stored in memory 542.

Hardware platform 540 supports the linear memory 530, a WASM runtime 510, an offloaded function runtime 520, and stack based virtual machines (VMs) 514 and 524. Like the stack based VMs 414 and 424 in computing system 400, in computing system 500, stack based VMs 514 and 524 run on respective logical cores 552a and 562a that are on different physical cores of different physical processors CPU 450 and GPU 460, respectively. In computing system 500, WASM runtime 510 manages, and coordinates resources for, WASM module 512, but another runtime (e.g., offloaded function runtime 520) manages and coordinates resources for the kernel function 522 that has been offloaded from WASM module 512. For example, WASM runtime 510 and stack based VM 514 cooperate to execute WASM binary code of WASM module 512, with the WASM runtime 510 facilitating interactions between the stack based VM 514 and CPU 550 and other hardware resources. Another runtime, e.g., offloaded function runtime 520, and stack based VM 524 cooperate to execute WASM binary code of offloaded function 522, with the offloaded function runtime 520 facilitating interactions between the stack based VM 524 and GPU 560 and other hardware resources. WASM runtime 510 and offloaded function runtime 520 may be implemented as separate instances of the same or different types of WASM runtime (e.g., WASITIME, Wasmer, WebAssembly Micro Runtime (WAMR), Lucet, etc.) programmed with additional functionality to enable the tagging, tracking, and synchronization described herein.

In at least one example, WASM module 512 (and corresponding WASM runtime 510) may be embedded in a browser or another guest user application. Similarly, the offloaded function 522 may be embedded in the browser or other guest user application.

In one or more embodiments, the offloaded function runtime 520 is configured to perform operations associated with memory tagging, tracking, and synchronization for WASM module 512 and offloaded function 522. In the example of FIG. 5, offloaded function runtime 520 is configured with tracking code 526 to enable tracking modifications of linear memory 530 allocated for the offloaded function 522 (e.g., callee tracked memory 534). In some implementations, offloaded function runtime 520 may be configured with an exception handler 527 to update the tag table and modified address list when a tag check failure (e.g., tag mismatch) occurs. Offloaded function runtime 520 may also be configured with synchronization code 528 to enable synchronization of the modified locations of the callee tracked memory 534 to corresponding locations of caller memory 532. Synchronization code 528 running in offloaded function runtime 520 can access and update caller memory 532. In one example, linear memory 530 is mapped to and/or configured as unified memory to enable the synchronization to access the caller memory 532 in addition to the callee tracked memory 534.

Memory 542 is similar to memory 442 of FIG. 4 and may be configured as unified memory in at least some embodiments. For example, unified memory may be embodied by memory 542 accessed via a unified memory interface 548. WASM module 512 and offloaded function 522 running on different stack based VMs 514 and 524 associated with different processors 550 and 560 of computing system 500 may each have access to unified memory, but different portions of the unified memory may be allocated to the WASM module and the offloaded function. Hardware platform 540 supports a linear memory 530 (e.g., similar to linear memory 430), which may be mapped to unified memory (e.g., memory 542 accessed via unified memory interface 548). The linear memory 530 may be apportioned into caller memory 532 allocated to WASM module 512 and callee tracked memory 534 allocated to the offloaded function 522. In addition, a modified address list 536 may be stored in the linear memory 530. In an implementation with a WASM module as shown in FIG. 5, caller memory 532 may be embodied as a WASM buffer for WASM module 512, and a caller tracked memory 534 may be embodied as a WASM buffer for the offloaded function 522. It should be noted that the linear memory 530 may be a single linear address space used by both the WASM module 512 and the offloaded function 522. In other implementations, the linear memory 530 may include two separate linear memories. In a scenario of separate linear memories, the WASM module 512 and offloaded function 522 may use the two separate linear memories, respectively, which are each mapped to the unified memory. In other implementations, WASM module 512 and offloaded function 522 may use respective contiguous physical address ranges in unified memory.

Similar to computing system 400, computing system 500 also supports memory tagging. Tracking code 516 and tag checking logic 546 may be implemented in any number of ways as previously described herein (e.g., tracking code 416, tag checking logic 136, 446). For example, tracking code 516 is configured to allocate (or cause the allocation of) callee tracked memory 534 for the offloaded function 522 when the offloaded function 522 is invoked by WASM module 512. In one or more embodiments, each granule in callee tracked memory 534 is marked with an allocation tag (e.g., a memory tag having a first value representing the color blue) indicating that the granule to which the memory tag is assigned has been allocated but not modified by the offloaded function. A pointer to the callee tracked memory 534 is generated with a callee tracked memory address (e.g., a base address of the callee tracked memory 534) and an addressing tag (e.g., a pointer tag having a second value representing the color green) that is different than the allocation tag assigned to each of the allocated granules in the callee tracked memory 534. A suitable number of bits in the pointer may be used to store an offset (e.g., relative to the base address) to enable the offloaded function to select any of the memory addresses in the callee tracked memory.

During a memory access operation for a target address in callee tracked memory 534, tag checking logic 546 may compare a pointer tag in a pointer used to access the target address to a memory tag that is stored in tag table 543 and assigned to a granule associated with the target address. If the pointer tag and the memory tag do not match, then an exception is raised. Otherwise, if the tags match, an exception is not raised. When an exception is raised, this indicates that the memory access operation might be modifying the callee tracked memory 534 at a memory address that has not been previously modified by the offloaded function.

The exception handler 527 may be configured to handle exception processing when an exception is raised. In some scenarios, the exception handler 527 may be configured as part of the offloaded function runtime 520. In other scenarios, the exception handler 527 may be separately provisioned, for example, based on the particular architecture of the computing system 500. If a memory access operation modifies the callee tracked memory 532 (e.g., via a write operation), then the exception handler 527 updates the memory tag assigned to the granule associated with the target address. The memory tag can be updated by replacing the allocation tag (e.g., first value representing the color blue) in the tab table 543 with the addressing tag (e.g., second value representing the color green) encoded in the pointer for the target address. If data in multiple granules is modified, then the respective allocation tags assigned to the multiple granules containing modified data can be updated in the tag table 543 with the addressing tag. In at least some implementations, the tag table 543 may be updated by accessing a shadow tag table 529.

The exception handler 527 (or other code, such as tracking code 526) updates the modified address list 536 with information indicating the target address of the memory operation. The information indicating the target address may include any suitable data such as a memory address, an offset to the target address, etc. In addition, in at least some embodiments, the information in the modified address list can indicate an address range (or offset range) that has been modified. The modified address list 536 may be implemented as any suitable data structure in which information can be incrementally added.

In the example computing system 500, when the WASM module 512 invokes the offloaded function 522, WASM module 512 and/or WASM runtime 510) may provide a caller memory address 515 to the offloaded function 522 and/or offloaded function runtime 520. The caller memory address may include a base address of caller memory 532. This enables synchronization code 528, which runs in another runtime, to know where caller memory 532 is located in linear memory 530 so that updates can be performed to the caller memory 532 based on the modified address list 536. The modified address list contains information indicating the locations in callee tracked memory 534 that were updated during the execution of offloaded function 522. The information in the modified address list may take any suitable form as previously described herein such as, for example, information contained in modified address list 436.

Embodiments that use memory tagging for tracking and synchronizing linear memory changes of kernel functions results in highly efficient operations. Memory tagging that is implemented in a portion of the address bits in a pointer can provide significant performance advantages by performing hardware-based pattern matching of addresses. Additionally, in at least some embodiments, special instructions could be used for bulk synchronization of a large set of addresses (or address ranges).

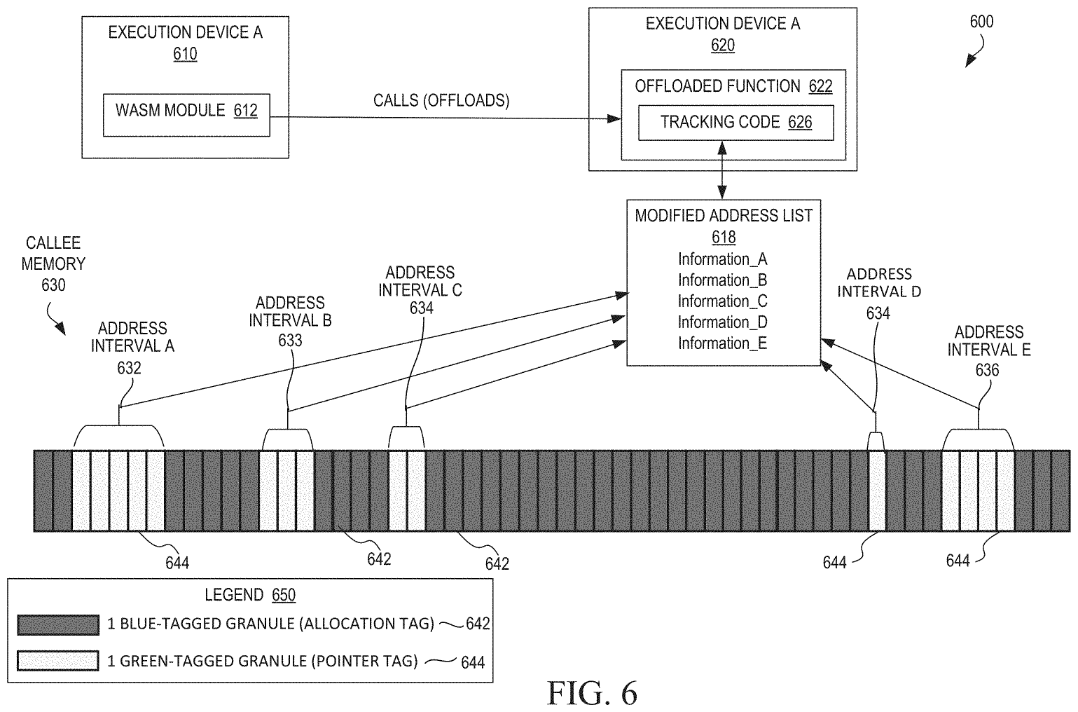

FIG. 6 is an illustration providing a visual representation 600 of an example scenario of memory tagging and tracking an offloaded function according to at least one embodiment. The visual representation 600 includes a first execution device 610, a second execution device 620, a modified address list 618, and callee memory 630. A WASM module 612 runs on the first execution device 610, and a kernel function 622 that is offloaded by the WASM module 612 runs on the second execution device 620. Depending on the implementation, callee memory 630 may be linear memory or physical memory. In an implementation with a WASM module, callee memory 630 may be embodied as a linear memory buffer for offloaded function 622. The first execution device 610 and the second execution device 620 are separate physical devices (e.g., CPUs, GPUs, IPUs, VPUs, DLPs, inference accelerators, other accelerators, etc., or any suitable combination thereof). The first and second devices 610 and 620 may access different portions of the same shared memory, such as memory based on unified memory technology, for example.

In one example, the first execution device 610 may be similar to CPUs 450 and 550, and the second execution device may be similar to GPUs 460 and 560. Similarly, WASM module 612 may be similar to WASM modules 412 and 512, offloaded function 624 may be similar to offloaded functions 422 and 522. Both the WASM module 612 and the offloaded function 622 may run in a WASM runtime, or in separate WASM runtimes. Tracking code 626 may be similar to tracking code 416 and 526, and may run in a WASM runtime that manages hardware resources at least for the offloaded function 622.

The callee memory 630 is a visual representation of tagged granules of callee memory 630 during (or after) the execution of offloaded function 622. The callee memory 630 may be allocated when the offloaded function 622 is invoked by the WASM module 612. Initially, each granule in the callee memory 630 is marked (e.g., assigned) an allocation tag. In one example, a tag table may be used to store tag values assigned to each granule in the callee memory. In one possible implementation, a tag table may contain a respective entry for each granule in the callee memory 630. Assigning an allocation tag to the granules of the callee memory 630 includes storing an allocation tag value in each entry of the tag table that is associated with one of the granules in the callee memory 630. Some of the tagged granules of callee memory 630 in FIG. 6 are referenced by reference numbers defined in a legend 650. For example, the legend 650 defines blue-tagged granules (e.g., 642) and green-tagged granules (e.g., 644). The blue-tagged granules 642 represent granules that are initially tagged with an allocation tag prior to the execution of the offloaded function 622. The green-tagged granules 644 represent granules containing data that has been modified by the offloaded function 622 and consequently, a pointer tag has been assigned to the granules containing modified data.

In this example, each address interval 632, 633, 634, 635, and 636 represents an interval of the callee memory 630 that has been modified. For example, address interval A 632 includes five granules, address interval B 633 includes three granules, address interval C 634 includes two granules, address interval D 635 includes one granule, and address interval E 636 includes four granules.

Modified address list 618 illustrates example contents corresponding to the modified data in the callee memory 630. When a memory access operation to a target address in callee memory 630 causes an exception to be raised, and the memory operation associated with the exception is a memory access operation that can modify the data at the target address (e.g., write operation), the modified address list 618 can be updated with information that indicates the location of the callee memory 630 that has been modified. For example, Information_A can indicate the location of interval A 632, Information_B can indicate the location of interval B 633, Information_C can indicate the location of interval C 634, Information_D can indicate the location of interval D 635, and Information_E can indicate the location of interval E 636. The information of an interval can include any suitable data that provides sufficient information to determine the location of the modified data. Examples of such information for a particular interval can include, but are not limited to, linear addresses for the beginning and end of the interval, offsets from the base address of the callee memory 630 to the beginning and end of the interval, linear addresses for each granule of data in an interval, offsets from the base address of the callee memory 630 to each granule of data in the interval, linear addresses for each addressable portion of memory within the interval, offsets from the base address of the callee memory 630 to each addressable portion of memory within the interval, or any suitable combination thereof.

Once the offloaded function 622 has finished executing, the modified address list 618 can be used to synchronize the callee memory 630 with a caller memory (not shown) that is allocated for WASM module 612. In the synchronization, synchronization code (e.g., 418, 528) can write each interval 632-636 of data in the callee memory 630 to corresponding addresses in the caller memory of the WASM module 612.

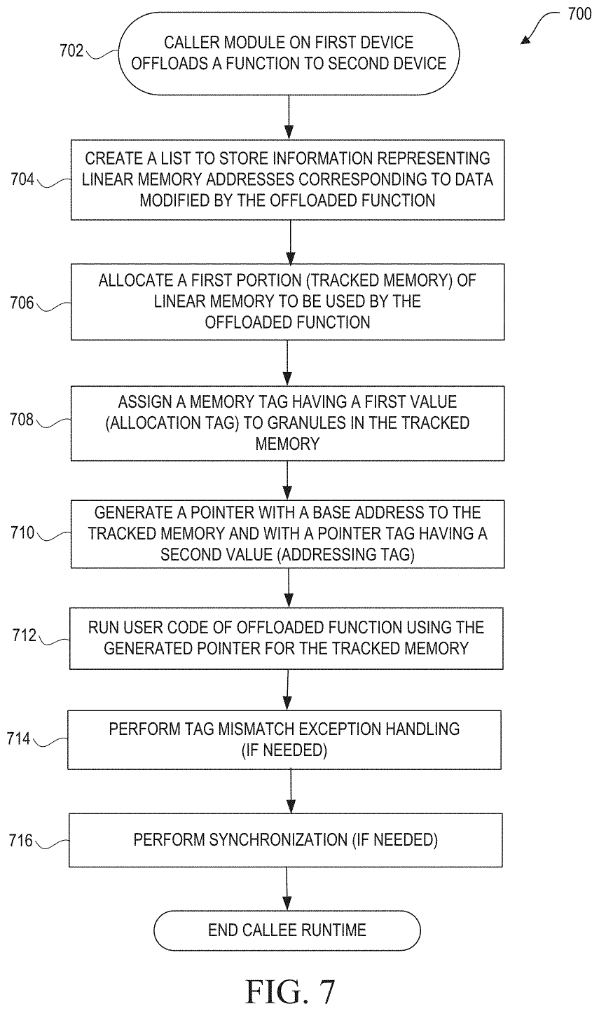

FIGS. 7-9 are flow diagrams of example processes that use memory tagging to synchronize memory contents in a heterogenous computing environment involving multiple devices (e.g., CPU, GPU, etc.). The processes of FIGS. 7-9 may be associated with one or more sets of operations. A computing system (e.g., host 104, computing systems 400, 500) may comprise means such as one or more processors (e.g., 130, 450, 460) for performing the operations. In one example, at least some operations shown in the processes of FIGS. 7-9 may be performed by a runtime that supports the execution of the offloaded function on a stack based virtual machine (e.g., 424, 524). In some implementations, a runtime (e.g., WASM runtime 410) may support the execution of both a caller module (e.g., WASM module 412) and the offloaded function (e.g., 422) on respective stack based VMs (e.g., 414 and 424). In other implementations, a runtime (e.g., offloaded function runtime 520) that supports the execution of the offloaded function (e.g., 522) on one stack based VM (e.g., 524) may be distinct from a runtime (e.g., WASM runtime 510) that supports the execution of the caller module (e.g., WASM module 512) on another stack based VM (e.g., 514).

FIG. 7 is a flow diagram of an example process 700 of possible operations for preparing memory tagging and tracking for an offloaded function according to at least one embodiment. In at least some implementations, the runtime associated with the offloaded function may be configured with tracking code (e.g., 416, 526), an exception handler (e.g., 417, 527), and/or synchronization code (e.g., 418, 528) to perform at least some of the operations of process 700. The memory used by the caller module and the offloaded function may be unified memory, which can be accessed by both devices on which the caller module (e.g., 412, 512) and the offloaded function (e.g., 422, 524) are running. The caller module has a memory portion that is synchronized or initialized to the same state, such as all zeros, as another memory portion that will be used by the offloaded function. The memory portions may be linear memory in the same or separate linear address spaces, or respective contiguous physical memory areas. In a WASM implementation, the memory portions may be embodied as respective WASM memory buffers.

Initially, at 702, a caller module (e.g., WASM module 412, 512) running on a first device (e.g., 414/450, 514/550) offloads a function to a second device (e.g., 424/460, 524/560). In some scenarios, the offloaded function may be one or more resource intensive computational task of user code that is to be performed by the caller module. The function may be offloaded to allow another processor such as a hardware accelerator to perform at least the intensive computational task. In one example, a compiler replaces code that is to be offloaded from the main thread of execution on one device (e.g., CPU 414/450, 514/550) to a second device (e.g., GPU 424/460, 524/560). The replaced code may include a sequence of instructions that include one or more of transferring data to the second device and initiating execution of the replaced code (e.g., precompiled binary image for the second device) on the second device.

At 704, a list is created. The list is to be used during the execution of the offloaded function to store information representing memory addresses corresponding to data that is modified during the execution of the offloaded function. In some scenarios, the information may include memory addresses, memory offsets, ranges of memory addresses, ranges of memory offsets, or any other suitable data that conveys the location of the modified memory.

At 706, a first portion of memory is allocated. The first portion of memory is to be used by the offloaded function during execution to perform its computational tasks. This first portion of memory is also referred to as ‘tracked memory.’ It should be appreciated that, in some implementations (e.g., FIG. 4), the first portion of memory may be allocated before the offloaded function is invoked. In this case, the caller module requests the runtime to allocate a block for the offloaded function that will be invoked. The runtime provides the memory address (e.g., base address) to the allocated new block (e.g., the tracked memory). This base address may then be passed back to the offloaded function when the offloaded function is invoked.

At 708, a memory tag having a first value, which is referred to herein as an ‘allocation tag,’ is assigned to granules in the tracked memory. Thus, each granule is tagged (e.g., marked) with an allocation tag. Tagging the granules can include storing the allocation tag for each granule in a tag table associated with the offloaded function. The allocation tag (e.g., representing the color blue) indicates that the tagged granule is allocated but not modified by the offloaded function. The granule may span one or more memory addresses. In at least one embodiment, the allocation tag is assigned to every granule in the tracked memory.

At 710, a pointer for the tracked memory is generated. The pointer may be encoded with a pointer tag and at least a portion of a base address of the tracked memory resulting from the allocation of the tracked memory at 706. The pointer can be used to range within the tracked memory via a modifiable offset in the pointer. Depending on the implementation, the pointer may be encoded with other metadata or information. It should be appreciated that any number of pointer encodings may be used in one or more embodiments including, but not necessarily limited to cryptographically encoded pointers. In cryptographically encoded pointers, some portions of the are encrypted (e.g., upper/fixed/base address bits, pointer tag, other metadata), and the contents of the memory referenced by the pointer may be encrypted based on a cryptographic algorithm (e.g., tweakable block cipher) that uses a tweak derived, at least in part, from the cryptographically encoded pointer.

At 712, the function is executed. The function may be, for example, a precompiled binary image for the second device, where the binary image is generated based on the replaced instructions from the caller module. Memory accesses by the function are directed to the tracked memory using the pointer encoded with the pointer tag and an offset to the target data.

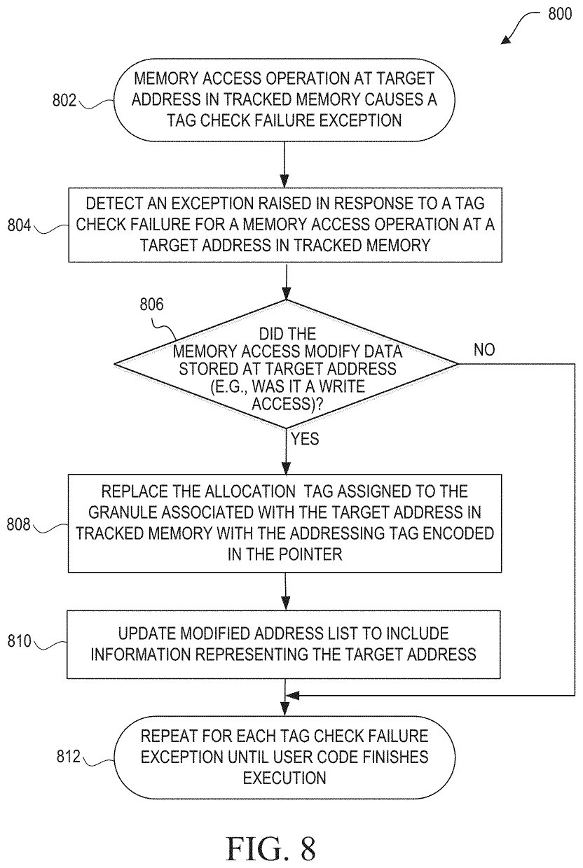

During the execution of the function, accesses to memory may result in a tag mismatch when memory is modified. In these scenarios, at 714, tag mismatch exception handling is performed to update the tag table storing the tags for the tracked memory addresses and to further update the list of modified addresses. Additional details related to 714 are shown and described with reference to FIG. 8.

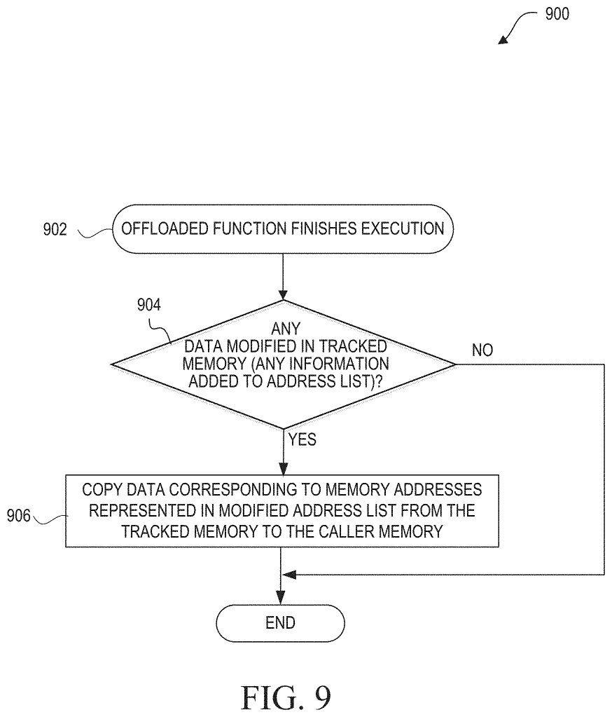

At 716, once the function completes execution, the modified address list can be used to synchronize the tracked memory allocated for the offloaded function with the memory of the caller module. Additional details related to 716 are shown and described with reference to FIG. 9.

FIG. 8 is a flow diagram of an example process 800 of possible operations for handling an exception based on a tag check failure in an offloaded function according to at least one embodiment. Process 800 includes one or more operations related to memory accesses occurring during the execution of an offloaded function (e.g., 422, 522). In some implementations, the runtime associated with the offloaded function may be configured with an exception handler (e.g., 417, 527) to perform at least some of the operations. In other implementations trap handler code may be separate from the runtime and invoked as needed by the runtime or other code.

At 802, a memory access operation (e.g., read, write, store, move, etc.) at a target address in the tracked memory causes a tag mismatch to occur in hardware. For example, upon reading the target address, tag checking logic 136, 446, 546) may retrieve a memory tag associated with the target address from a tag table and compare the retrieved memory tag to the pointer tag in the pointer to the target address. If the tags do not match, this indicates that the allocation tag is still associated with the target address as the target address has not yet been modified during the function execution. If the tags do match, this indicates that the target address has been modified during the execution of the function and that the pointer tag is assigned to the target address in the tag table.

The exception handler (e.g., 417, 527) in this embodiment does not cause the execution of the offloaded function to terminate (or abnormally end) when an exception occurs. Instead, the exception triggers a determination by the exception handler as to whether tracked memory has been modified during the execution of the offloaded function. Operations that are performed when an exception occurs are further detailed in process 800.

At 804, the runtime detects an exception raised in response to a tag check failure for a memory access operation at a target address in the tracked memory. In at least one embodiment, a tag check failure is a determination that a pointer tag in a pointer used to access a target address in the tracked memory does not match (or otherwise correspond to) a memory tag assigned to a granule associated with the target address.

At 806, a determination is made as to whether the memory access operation modified the data (also referred to as ‘target data’)_stored at the target address. For example, if the memory access was a write operation, then the data at the target address is presumed to have been modified by the offloaded function. If the memory access was a read operation, then the data at the target address was not modified by the offloaded function.

If a determination is made that the tracked memory was modified based on the performed memory access operation (e.g., a write operation), this indicates that the tag table contains a tag assigned to a granule associated with the target address that does not match the pointer tag encoded in the pointer for the target address. In this scenario, the tag in the tag table may be the allocation tag that was used to initialize the granule associated with the target address when the tracked memory was allocated. Accordingly, at 808, the allocation tag that is assigned to the granule associated with the target address in the tracked memory, and that is stored in the tag table, is replaced with the addressing tag from the target address pointer.

At 810, the modified address list is updated to include information representing the target address. This information could be a single memory address or range of memory addresses, an offset from the base address of the tracked memory or a range of offsets, or any other suitable identifying information that specifies or otherwise indicates the memory location or memory interval in the tracked memory that has been modified.

At 806, if a determination is made that the memory access operation did not modify the target address in the tracked memory (e.g., a read operation), this indicates that the tag table contains a tag assigned to the target address that matches the pointer tag encoded in the pointer for the target address. In this scenario, the updates may not be performed in the tag table and the modified address list. As noted at 812, one or more of the operations of process 800 may be repeated for each tag check failure exception that occurs until the user code finishes execution.

In other implementations, the check performed at 806 may be omitted and the tags assigned to all accessed memory may be updated with the pointer tag in the pointer used to access the memory. In this case, the modified address list may include information representing some tracked memory address (or interval of tracked memory) that was not updated during the function execution but was only read. Thus, in this variation, synchronization with caller memory may be performed for some tracked memory that has not been changed.

FIG. 9 is a flow diagram of an example process 900 of possible operations for synchronizing memory of an offloaded function with a caller module according to at least one embodiment. Process 900 includes one or more operations occurring once the offloaded function has finished executing. At 902, the offloaded function finishes executing. At 904, a determination is made as to whether any data was modified in the tracked memory during the function execution. This determination can be made based on the contents of the modified address list. If the modified address list is empty, this indicates that none of the tracked memory was modified during the function execution, and the flow can end.

Alternatively, if the modified addresses list is not empty (e.g., contains information representing one or more addresses in the tracked memory or one or more intervals of tracked memory), then at 906, the tracked memory used by the second device running the offloaded kernel function is synchronized with a portion of caller memory of the first device, that corresponds to the tracked memory of the second device. For example, the data that is stored at an address in the tracked memory that corresponds to a memory address represented in the modified address list, is copied to a portion of the memory allocated to the caller module.

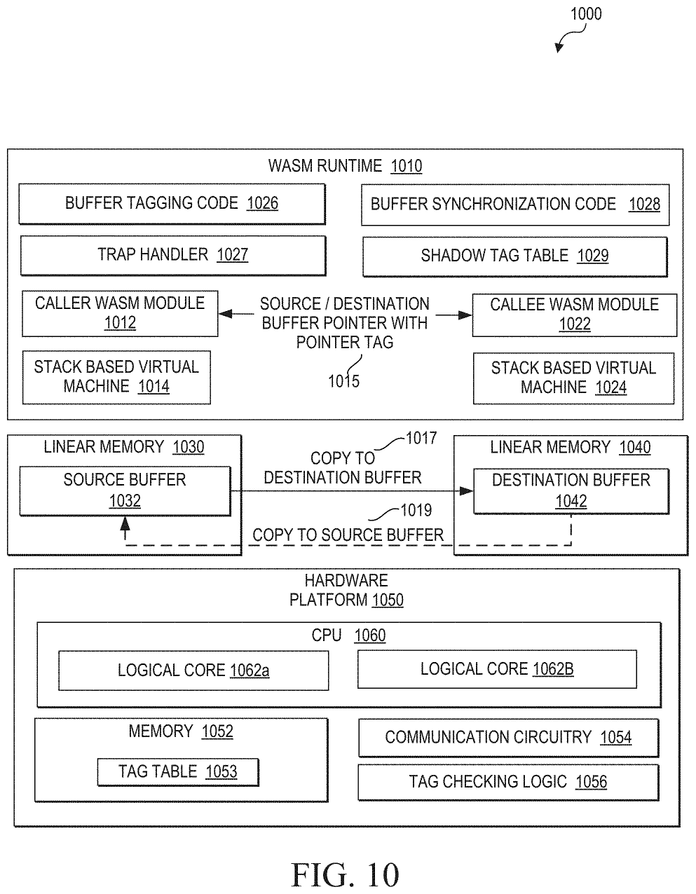

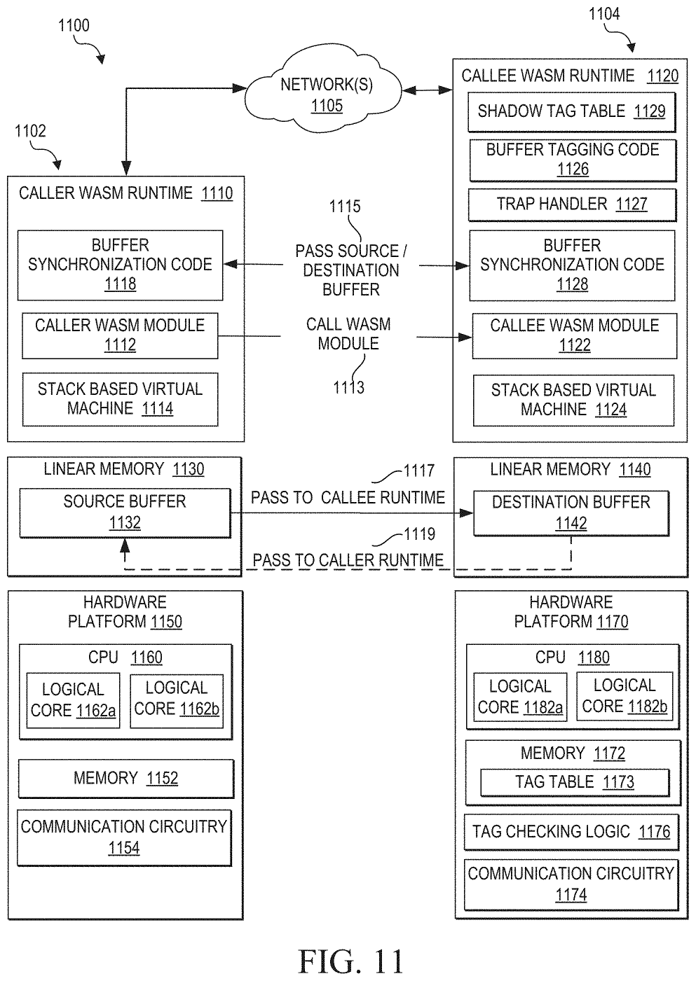

FIGS. 10-11 are block diagrams of example computing systems that illustrate embodiments utilizing memory tagging and tracking to minimize memory copying operations or transmission operations for component interactions. The memory tagging and tracking embodiments shown in FIGS. 10-11 involve component interactions such as function invocations between components on the same device or different devices with their own linear memories. One nonlimiting example involves copy-on-write for large buffers passed through a WebAssembly interface type boundary. In this scenario, two WASM instances run on the same device (FIG. 10) or different devices (FIG. 11) with their own linear memories. Currently, using interface types, non-scalar values (e.g., byte buffers, strings, structures) need to be copied from one memory (e.g., a source buffer) to another memory (e.g., a destination buffer) when calling from one WASM module to another WASM module.

Memory tagging is used in embodiments shown in FIGS. 10-11 to determine whether the callee WASM module modifies any data in the destination buffer. If the callee WASM module does not modify any of the data in the destination buffer, then no copy to the source buffer or transmission to the caller WASM module is needed. If the callee WASM module does modify data in the destination buffer, then for WASM modules running in the same runtime, a copy can be performed (e.g., lazily) and the memory address encoded in the pointer to the destination buffer can be replaced with the copied-to address of the source buffer. For WASM modules running in different runtimes and on different devices, a transmission can be performed (e.g., lazily) from the callee module to the caller module only if the destination buffer has been modified. Determining whether a modification of data in the destination buffer was performed can be accomplished using any suitable approach. For example, a tag mismatch, where a pointer tag encoded in a pointer to a target address does not match a memory tag of a granule associated with the target address can be trapped (e.g., an exception can be raised) and a trap handler can determine whether the instruction associated with the memory operation was a load instruction or a store instruction. In another example, if the processor can confirm statically that the callee module does not modify the destination buffer, then the pointer tag encoded in the pointer for the destination buffer can be changed to match the memory tag assigned to the destination buffer. The pointer tag can be changed before a memory access operation on the destination buffer is performed. Alternatively, the memory tag for each granule of the destination buffer can be changed to match the pointer tag.

It should be noted that, for illustrative purposes, the components in the example computing systems illustrated in FIGS. 10-11 include caller WASM modules and callee WASM modules invoked by the caller WASM modules. It should be apparent, however, the techniques described herein with respect the memory tagging and tracking for component interactions could also be applied to components (or modules) compiled from software languages other than WebAssembly.

FIG. 10 is a block diagram illustrating an example computing system 1000 implementing a memory tagging and tracking technique for component interactions according to at least one embodiment. For illustrative purposes, the components in the example computing system 1000 include a caller WASM module 1012 and a callee WASM module 1022 that is called or otherwise invoked by the caller WASM module 1012. It should be apparent, however, that the techniques described herein could also apply to modules compiled from other software languages.

Computing system 1000 includes an example hardware platform 1050 that supports linear memories 1030 and 1040, a WASM runtime 1010, and stack based virtual machines (VMs) 1014 and 1024. The hardware platform 1050 can include a physical processor, such as central processing unit (CPU) 1060, memory 1052, communication circuitry 1054, and tag checking logic 1056. Computing system 1000 is one example of host 104, including processors such as CPU 1060 (e.g., similar to processor 130), WASM runtime 1010 (e.g., similar to WASM runtime 120), linear memory 1030 and 1040 (e.g., similar to linear memory of storage 140), and communication circuitry 1054 (e.g., similar to communication circuitry 118). In computing system 1000, respective linear memories 1030 and 1040 are allocated for the respective WASM modules 1012 and 1022. Alternatively, embodiments to tag, track, and synchronize component interactions could be implemented with a single linear memory space that could be used for both the caller WASM module 1012 and the callee WASM module 1022. In other implementations, caller WASM module 1012 and callee WASM module 1022 may be allocated respective contiguous physical address ranges in memory 1052. Memory 1052 may or may not be embodied as unified memory.

CPU 1060 is shown for illustration purposes only as the hardware platform may include one or more physical processors that allow WASM modules (e.g., 1012 and 1022) to run on the same processor (e.g., CPU 1060) or different processors accessing different linear memories 1030 and 1040. By way of example, processors of hardware platform 1050 could include, but are not limited to, CPUs, GPUs, VPUs, IPUs, DLPs, inference accelerators, other accelerators, or any suitable combination thereof. The processors of hardware platform 1050 may each be single threaded or multithreaded and may each include a single core or multiple cores. In this example, CPU 1060 includes logical core 1062a and logical core 1062b, which may correspond to threads of the same physical core of CPU 1060 (e.g., for multithreading) or different physical cores of CPU 1060.

In example computing system 1000, stack based VMs 1014 and 1024 may run on respective logical cores 1062a and 1062b that are on CPU 1060. Accordingly, stack based VMs 1014 and 1024 abstract low-level hardware interactions of CPU 1060 and other components of hardware platform 1050. WASM runtime 1010 manages, and coordinates resources for, caller WASM module 1012 and callee WASM module 1022. More specifically, WASM runtime 1010 facilitates interactions between the stack based virtual machines and hardware platform 1050. For example, WASM runtime 1010 and stack based VM 1014 cooperate to execute WASM binary code of caller WASM module 1012, with WASM runtime 1010 facilitating interactions between the stack based VM 1014 and CPU 1060 and other hardware resources. Similarly, WASM runtime 1010 and stack based VM 1024 cooperate to execute WASM binary code of callee WASM module 1022, with WASM runtime 1010 facilitating interactions between the stack based VM 1024 and CPU 1060 and other hardware resources. WASM runtime 1010 may be implemented as any suitable WASM runtime (e.g., WASITIME, Wasmer, WebAssembly Micro Runtime (WAMR), Lucet, etc.) and programmed with additional functionality to enable the tagging, tracking, and synchronization described herein.

In at least one example, the WASM modules 1012 and 1022 (and corresponding WASM runtime 1010) may be embedded in a browser or another guest user application. A guest user application can be embodied as a WASM component comprising one or more WASM modules such as WASM modules 1012 and 1022 and managed by a WASM runtime. In some scenarios, the WASM modules 1012 and 1022 are compiled from different higher level software languages (e.g., C, C++, Python, Go, Rust, etc.) into WASM binary code. In other scenarios, the WASM modules 1012 and 1022 may be compiled from the same higher level software language into WASM binary code.

Memory 1052 may include any suitable memory or storage, including for example, storage 140 of FIG. 1. Caller WASM module 1012 and callee WASM module 1022 can run on different stack based VMs 1014 and 1024 associated with different linear memories 1030 and 1040, respectively, that map to memory 1052. A source buffer 1032 may be allocated for caller WASM module 1012, and a destination buffer 1042 may be allocated for callee WASM module 1022. In addition, a tag table 1053 may be stored in memory 1052. For implementations with WASM modules as shown in FIG. 10, source and destination buffers 1032 and 1042 may be embodied as linear memory buffers. The concepts shown in FIG. 10, however, are also applicable to other types of software modules that pass memory buffers when invoking another module. In these other implementations, source and destination buffers 1032 and 1042 can be any suitable contiguous memory for storing data.

Computing system 1000 may be configured to support memory tagging as shown and described herein. For example, hardware platform 1050 may include tag checking logic 1056 (e.g., similar to tag checking logic 136 in host 104 of FIG. 1). Tag checking logic 1056 may be implemented in CPU 1060, as a discrete component, integrated with another component having other functionality (e.g., memory controller) in hardware platform 1050, or a suitable combination thereof. Furthermore, tag checking logic 1056 may be implemented in firmware, software, or any combination of firmware, software, and/or hardware. In addition, tag table 1053 (e.g., similar to tag table 143) may contain memory tags assigned to granules associated with memory addresses of destination buffer 1042. During a memory access operation for a target address in destination buffer 1042, tag checking logic 1056 may compare a pointer tag in a pointer used to access the target address to a memory tag that is stored in tag table 1053 and assigned to a granule associated with the target address. If the pointer tag and the memory tag do not match, then an exception is raised. Otherwise, if the tags match, an exception is not raised.

In one or more embodiments, WASM runtime 1010 is configured to perform operations associated with tagging, tracking, and synchronization for caller WASM module 1012 and callee WASM module 1022. In the example of FIG. 10, WASM runtime 1010 is configured with buffer tagging code 1026 to enable detection of modifications of destination buffer 1042 in linear memory 1040 allocated for the callee WASM module 1022. In some implementations, WASM runtime 1010 may be configured with a trap handler 1027 to update the tag table and write-back flag when a tag check failure (e.g., tag mismatch) occurs. WASM runtime 1010 may also be configured with buffer synchronization code 1018 to enable synchronization of the destination buffer 1042 to the source buffer 1032.

Source buffer 1032 may contain parameters to be passed to the callee WASM module 1022 when invoked, and to be accessed by the callee WASM module 1022 during execution. In at least one embodiment, before the callee WASM module is executed, the source buffer 1032 is copied into the destination buffer 1042 by the WASM runtime 1010 as indicated at 1017. Conversely, once the callee WASM module 1022 finishes executing, if any modifications have been made to the destination buffer 1042, then the destination buffer 1042 (or modified portions thereof) are copied into the source buffer 1032 by the WASM runtime 1010 as indicated at 1019.

As previously discussed herein (e.g., with reference to FIG. 3, for example), in WebAssembly, an interface type is used to convert the language-native type of caller WASM module 1012 to the language-native type of callee WASM module 1022, and vice versa. For example, adapter instructions can be used to convert language-native types of the caller WASM module 1012 to the appropriate interface types, and to convert the interface types to language-native types of the callee WASM module 1022. Conversely, other adapter instructions can be used to convert the language-native types of the callee WASM module 1022 to the interface types, and to convert the interface types to the language-native types of the caller WASM module 1012. The adapter instructions may be implemented in the WASM modules or runtime in some implementations. In other implementations, the adapter instructions may be performed in a dedicated hardware device to perform the conversions or in a separate software entity.

In one example, buffer synchronization code 1028 of WASM runtime 1010 may be configured to perform or facilitate copying source data from the source buffer 1032 into the destination buffer 1042 when the callee WASM module 1022 is invoked by the caller WASM module 1012. When caller WASM module 1012 calls callee WASM module 1022, caller WASM module 1012 may pass a source buffer pointer 1015 to callee WASM module 1022. Buffer synchronization code 1028 may use the source buffer pointer 1015 to copy the data from the source buffer 1032 to the destination buffer 1042. The buffer synchronization code 1028 may also perform or facilitate conversions needed to convert the language-native types in the source buffer 1032 to language-native types for the destination buffer 1042.

Buffer tagging code 1026 may be configured to perform operations associated with memory tagging of data (e.g., parameters from source buffer) in destination buffer 1142 before the callee WASM module is executed. Once the destination buffer contains the parameters from the source buffer 1032, each granule in the destination buffer 1042 is marked with a memory tag having a particular first value (e.g., representing a color blue) indicating that the granule to which the memory tag is assigned has not been modified by the callee WASM module 1022. A memory tag having the particular first value (e.g., representing the color blue) is also referred to herein as an ‘allocation tag’. Marking the destination buffer 1042 can include storing the memory tag (e.g., the first value) in tag table 1053 for each granule of the destination buffer. The tag table 1053 may contain a memory tag entry for each granule of the destination buffer 1042. A granule can be any number of bytes in memory that represents the tagging granularity. For example, a granule may be 4 bytes, 8 bytes, 16 bytes, 32 bytes, or more. Additionally, a granule may span one or more memory addresses (or offsets from a base address of the destination buffer).

In at least some implementations, a shadow tag table 1019 can be used by WASM runtime 1010 to access (e.g., read, write) memory tags in memory 1052 (e.g., main memory) used during execution of the callee WASM module 1022. Accordingly, buffer copy and tagging code 1026 can access the shadow tag table 1019 to assign the allocation tag to the granules of the destination buffer before the callee WASM module 1022 is executed.

Buffer tagging code 1026 may also be configured to generate a pointer to the destination buffer 1042, using a destination buffer memory address (e.g., a base address of the callee tracked memory 434) and a pointer tag having a second value (e.g., representing the color green) that is different than the first value (e.g., representing the color blue) of the allocation tag assigned to each of the granules in the destination buffer 1042. A pointer tag having a second value (e.g., representing the color green) is also referred to herein as an ‘addressing tag’. A suitable number of bits in the pointer may be used to store an offset (e.g., relative to the base address) to enable the callee module to select any of the memory addresses in the destination buffer to access. Each time a memory access operation is performed on a target address in the destination buffer 1042, a tag check is performed to determine whether the addressing tag in the pointer to the target address matches a memory tag stored in the tag table for the granule associated with the target address. If the tags do not match, then an exception is raised. When an exception is raised, this indicates that the memory access operation might be modifying the destination buffer 1042.

The trap handler 1027 may be configured to handle exception processing when an exception is raised. In some scenarios, the trap handler 1027 may be configured as part of WASM runtime 1010. In other scenarios, the trap handler 1027 may be separately provisioned, for example, based on the particular architecture of the computing system 1000. If the memory access operation stores data in the destination buffer 1042 (e.g., performs a write operation, etc.), then the data at the target address is presumed to have been modified by the callee WASM module. If the memory access was a read operation, then the data at the target address has not been modified by the callee WASM module. If the data has been modified, the trap handler 1027 provides an indication that the destination buffer 1042 was modified during the execution of the callee WASM module. The indication can be provided using any suitable technique. In one example, a write-back flag is set on the destination buffer 1042. The write-back flag can be set by storing a particular value (e.g., ‘1’) to indicate that the destination buffer 1042 has been modified during the callee WASM module's execution and therefore, the source buffer should be updated when the callee WASM module 1022 returns control to the caller WASM module 1012. Conversely, if write-bag flag contains another value (e.g., ‘0’), this can indicate that the destination buffer was not modified by the callee WASM module and therefore, the source buffer does not need to be updated when the callee WASM module returns control to the caller WASM module.

The trap handler 1027 may also update the pointer to the memory address if the determination is made that the data at the memory address has been modified. In this scenario, the addressing tag (e.g., second value representing the color green) encoded in the pointer can be updated to contain the allocation tag (e.g., first value representing the color blue) assigned to the granule associated with the memory address of the memory access operation. By updating the pointer tag, future memory accesses to the destination buffer 1042 avoid tag mismatches and, therefore, minimize unnecessary processing.

In an alternative embodiment, however, instead of using a write-back flag and updating the pointer tag, an embodiment may use memory tagging, tracking, and synchronizing as previously described herein with reference to at least FIGS. 4-9. In this embodiment, only the modified portions of the destination buffer are updated in the corresponding memory addresses of the source buffer. For example, in an implementation such as FIG. 10, only the modified data in the destination buffer is returned to the caller module. In addition, other information may also be provided to the caller module that indicates which portions of the destination buffer are being returned to the caller to enable updates to the corresponding memory addresses in source buffer 1032. For example, a list of addresses, offsets, and/or address or offset ranges of the returned data may also be returned to the caller module to enable the caller module to update the appropriate addresses in the source module that correspond to the modified addresses in the destination buffer. Also, if the caller WASM module 1012 and the callee WASM module 1022 share a runtime, such as WASM runtime 1010, then the runtime may use the modified address list to selectively copy the modified addresses from the destination buffer to the corresponding addresses in the source buffer.

Buffer synchronization code 1028 may also be part of WASM runtime 1010 to perform synchronization operations to synchronize (e.g., update) the source buffer 1032 with data in the destination buffer 1042 (or the modified portions thereof). Buffer synchronization code 1028 may be configured to determine whether the indication (e.g., write-back flag) provided by the trap handler 1027 indicates that the destination buffer has been modified and therefore, that the source buffer needs to be updated. If the determination is made that the source buffer needs to be updated, then the WASM runtime 1010 can copy the data in destination buffer (or modified portions thereof) to the source buffer as indicated at 1019. In this scenario, the destination buffer data can be converted from a native type of the software language of the callee WASM module 1022 into intermediate data having an interface type. The intermediate data can be converted from the interface type to source data having a native type of the software language of the caller WASM module 1012. The buffer synchronization code 1028 may perform or facilitate the conversions of the data. The source data having the native type of the software language of the caller WASM module 1012 can be stored in the source buffer 1032 by the runtime (e.g., buffer synchronization code 1028) that manages the caller WASM module.

FIG. 11 is a block diagram illustrating an example computing environment 1100 implementing a memory tagging and tracking technique for component interactions according to at least one embodiment. Computing environment 1100 has some similarities to computing system 1000 of FIG. 10, with like names for like elements. Computing environment 1100, however, provides a caller WASM module 1112 and a callee WASM module 1122 in separate devices that may communicate over a network 1105. The network 1105 may include one or more wired or wireless networks (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

Computing environment 1100 includes two example computing systems 1102 and 1104. Computing systems 1102 and 1104 have respective example hardware platforms 1150 and 1170, which can be similar to hardware platform 1050 of computing system 1000 in FIG. 10. The hardware platform 1150 of computing system 1102 supports linear memory 1130, a WASM runtime 1110, and a stack based virtual machine (VM) 1114, which can be similar to linear memory 1030, WASM runtime 1010, and stack based VM 1014, respectively. The hardware platform 1150 includes a CPU 1160 with two logical cores 1162a and 1162b, memory 1152, and communication circuitry 1154, which can be similar to CPU 1060 with logical cores 1062a and 1062b, memory 1052, and communication circuitry 1054, respectively.

The hardware platform 1170 of computing system 1104 supports linear memory 1140, a WASM runtime 1120, and a stack based virtual machine (VM) 1124, which can be similar to linear memory 1040, WASM runtime 1010, and stack based VM 1024, respectively. The hardware platform 1170 can include a CPU 1180 with two logical cores 1182a and 1182b, memory 1172 with a tag table 1173, communication circuitry 1174, and tag checking logic 1176, which can be similar to CPU 1060, memory 1052 with tag table 1053, communication circuitry 1054, and tag checking logic 1056, respectively. In computing environment 1100, respective linear memories 1130 and 1140 are allocated for respective WASM modules 1112 and 1122 and are mapped to respective main memories 1152 and 1172. In other implementations, caller WASM module 1112 and callee WASM module 1122 may be allocated contiguous physical address ranges in memories 1152 and 1172, respectively. Memories 1152 and 1172 may or may not be embodied as unified memories.

CPUs 1160 and 1180 are shown for illustration purposes only as the hardware platforms 1150 and 1170 may include one or more physical processors on which WASM modules (e.g., 1112 and 1122) can run and communicate with each other via network 1105. By way of example, processors of hardware platforms 1150 and 1170 could be similar to processors of hardware platform 1050 of FIG. 10.

In example computing environment 1100, stack based VMs 1114 and 1124 may run on respective logical cores (e.g., 1062a and 1082a) that are on respective CPUs 1060 and 1080. The stack based VMs 1114 and 1124 can be similar to stack based VMs 1014 and 1024. For example, WASM runtime 1110 and stack based VM 1114 cooperate to execute WASM binary code of caller WASM module 1112, with WASM runtime 1110 facilitating interactions between the stack based VM 1114 and CPU 1160 and other hardware resources. Similarly, WASM runtime 1120 and stack based VM 1124 cooperate to execute WASM binary code of callee WASM module 1122, with WASM runtime 1120 facilitating interactions between the stack based VM 1124 and CPU 1180 and other hardware resources. WASM runtimes 1110 and 1120 may be implemented as any suitable WASM runtimes (e.g., WASITIME, Wasmer, WebAssembly Micro Runtime (WAMR), Lucet, etc.) and programmed with additional functionality to enable the memory tagging, tracking, and synchronization described herein.

In at least one example, the WASM modules 1112 and 1122 (and their respective WASM runtimes 1110 and 1120) may be embedded in respective browsers or other guest user applications, as described with reference to WASM modules 1012 and 1022 and WASM runtime 1010 of FIG. 10. In some scenarios, the WASM modules 1112 and 1122 are compiled from different higher level software languages (e.g., C, C++, Python, Go, Rust, etc.) into WASM binary code. In other scenarios, the WASM modules 1112 and 1122 may be compiled from the same higher level software language into WASM binary code.

Memories 1152 and 1172 may include any suitable memory or storage, and may each be similar to memory 1052 of FIG. 10. Caller WASM module 1112 and callee WASM module 1122 can run on different stack based VMs 1114 and 1124 associated with different linear memories 1130 and 1140, respectively, that map to respective memories 1152 and 1172. A source buffer 1132 may be allocated for caller WASM module 1112, and a destination buffer 1142 may be allocated for callee WASM module 1122. For implementations with WASM modules as shown in FIG. 11, source and destination buffers 1132 and 1142 may be embodied as linear memory buffers. The concepts shown in FIG. 11, however, are also applicable to other types of software modules that pass memory buffers when invoking another module. In these other implementations, source and destination buffers 1132 and 1142 can be any suitable contiguous memory for storing data.

Computing system 1104 may be configured to support memory tagging, for example, as shown and described with reference to computing system 1000 of FIG. 10. For example, hardware platform 1170 may include tag checking logic 1176 (e.g., similar to tag checking logic 1056 in FIG. 10). In addition, a tag table 1173 (e.g., similar to tag table 1053) may be stored in memory 1172. Tag checking logic 1176 may be implemented in CPU 1180, as a discrete component, integrated with another component having other functionality (e.g., memory controller) in hardware platform 1170, or a suitable combination thereof. Furthermore, tag checking logic 1176 may be implemented in firmware, software, or any combination of firmware, software, and/or hardware. In addition, tag table 1173 (e.g., similar to tag table 1053) may contain memory tags assigned to granules associated with memory addresses of destination buffer 1142. During a memory access operation for a target address in destination buffer 1142, tag checking logic 1176 may compare a pointer tag in a pointer used to access the target address to a memory tag that is stored in tag table 1173 and assigned to a granule associated with the target address. If the pointer tag and the memory tag do not match, then an exception is raised. Otherwise, if the tags match, an exception is not raised.

In one or more embodiments, WASM runtime 1120 is configured to perform operations associated tagging and tracking for callee WASM module 1022. In the example of FIG. 11, WASM runtime 1120 is configured with buffer tagging code 1126 to enable detection of modifications of destination buffer 1143 in linear memory 1140 allocated for the callee WASM module 1122. In some implementations, WASM runtime 1120 may be configured with a trap handler 1127 to update the tag table and write-back flag when a tag check failure (e.g., tag mismatch) occurs. The callee WASM runtime 1120 and caller WASM runtime 1110 may be configured with cooperating buffer synchronization code 1128 and 1118, respectively, to enable synchronization of the modified destination buffer 1142 to the source buffer 1132.

Source buffer 1132 may contain parameters to be passed to the callee WASM module 1122 when invoked. In at least one embodiment, when the callee WASM module is called (or otherwise invoked) as shown at 1113, the caller WASM runtime 1110 passes the source buffer 1132 to the callee WASM runtime 1120. In at least one embodiment, passing parameters may be performed via buffer synchronization codes 1118 and 1128 of WASM runtimes 1110 and 1120 as shown at 1115. parameters in source buffer 1132 to be stored in destination buffer 1142, as indicated by 1117. Buffer synchronization code 1128 can store parameters from the source buffer 1132 in destination buffer 1142, as indicated by 1117. Conversely, once the callee WASM module 1122 finishes executing, if any modifications have been made to the destination buffer 1142, then the callee WASM runtime 1120 passes the destination buffer 1142 (or modified portions thereof) to the caller WASM runtime 1110. In at least one embodiment, passing return values may be performed via buffer synchronization codes 1118 and 1128 of WASM runtimes 1110 and 1120 as shown at 1115. Buffer synchronization code 1118 can store return values from the destination buffer 1142 in source buffer 1132, as indicated by 1119.

As previously discussed herein (e.g., with reference to FIGS. 3 and 10), in WebAssembly, an interface type is used to convert the language-native type of caller WASM module 1112 to the language-native type of callee WASM module 1122, and vice versa. For example, adapter instructions can be used to convert language-native types of the caller WASM module 1112 to the appropriate interface types, and to convert the interface types to language-native types of the callee WASM module 1122. Conversely, other adapter instructions can be used to convert the language-native types of the callee WASM module 1122 to the interface types, and to convert the interface types to the language-native types of the caller WASM module 1112. The adapter instructions may be implemented in the WASM modules or runtime in some implementations. In other implementations, the adapter instructions may be performed in a dedicated hardware device to perform the conversions or in a separate software entity.

In one example, buffer synchronization code 1118 of caller WASM runtime 1110 may be configured to facilitate converting the parameters in source buffer 1132 having language-native types of caller WASM module 1112 to interface types, sending the interface types to callee WASM runtime 1120. Buffer synchronization code 1128 of callee WASM runtime 1120 may be configured to receive the interface types, convert the interface types to language-native types of the callee WASM module 1122, and store the language-native types in destination buffer 1142. Conversely, buffer synchronization code 1128 of callee WASM runtime 1120 may be configured to facilitate converting the return values in destination buffer 1142 having language-native types of callee WASM module 1122 to interface types, sending the interface types to caller WASM runtime 1110. Buffer synchronization code 1118 of caller WASM runtime 1110 may be configured to receive the interface types, convert the interface types to language-native types of the caller WASM module 1112, and store the language-native types in source buffer 1132.

Buffer tagging code 1126 and trap handler 1127 may be configured to perform the same or similar operations as buffer tagging code 1026 and trap handler 1027 of WASM runtime 1010 of FIG. 10. In addition, shadow tag table 1129 may be used in the same or similar manner as shadow tag table 1029 of WASM runtime 1010 of FIG. 10. Accordingly, additional detailed discussion of these components is omitted.

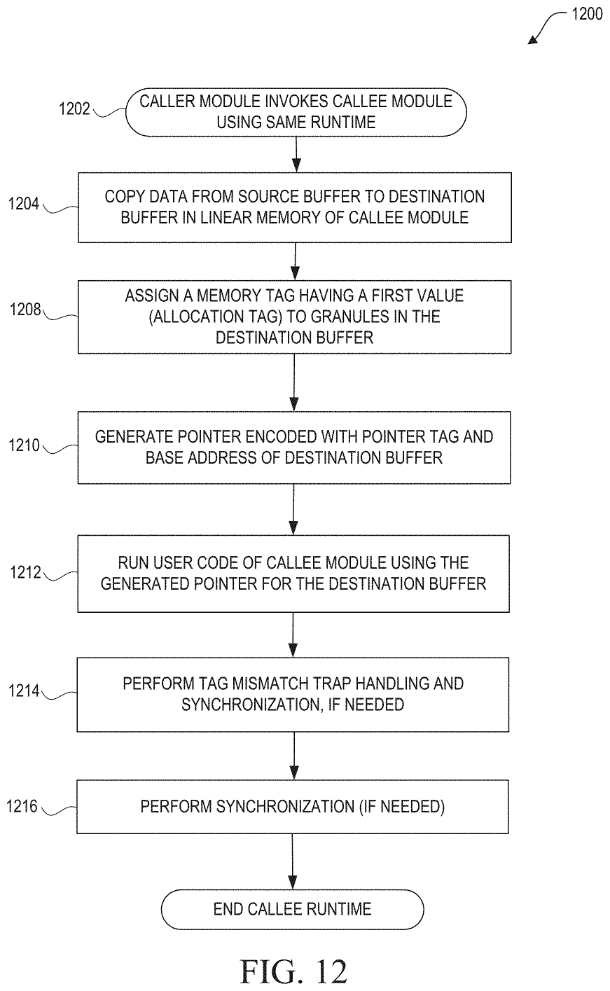

FIGS. 12-15 are flow diagrams of example processes that use memory tagging and tracking to minimize memory copying operations for component interactions. The processes of FIGS. 12-15 may be associated with one or more sets of operations. A computing system (e.g., host 104, computing system 1000) may comprise means such as one or more processors (e.g., 130, 1060, 1080) for performing the operations. In one example, at least some operations shown in the processes of FIGS. 12-15 may be performed by a runtime that supports the execution of the callee module. In some implementations, a runtime (not shown) may support the execution of both a caller module (e.g., WASM module 1012) and the callee module (e.g., 1022) invoked by the caller module. In some implementations, as shown in FIG. 10, the runtime (e.g., WASM runtime 1020) that supports the execution of the callee module (e.g., 1022) on one stack based VM (e.g., 1024) may be distinct from the runtime (e.g., WASM runtime 1010) that supports the execution of the caller module (e.g., WASM module 1012) on another stack based VM (e.g., 1014). In other implementations, a runtime (not shown) may support the execution of both a caller module (e.g., WASM module 1012) and the callee module (e.g., 1022) invoked by the caller module.

FIG. 12 is a flow diagram of another example process 1200 of possible operations for preparing memory tagging and tracking for a callee module invoked by a caller module, according to at least one embodiment. FIG. 10 illustrates one possible architecture in which the process 1200 may be implemented. In this example, the caller module (e.g., caller WASM module 1012) and the callee module (e.g., callee WASM module 1022) are running on the same device (e.g., stack based VMs 1014 and 1024 on CPU 1060) supported by the same runtime (e.g., WASM runtime 1010). In at least some implementations, the runtime may be configured with buffer tagging code (e.g., 1026), a trap handler (e.g., 1027), and/or synchronization code (e.g., 1028) to perform at least some of the operations of process 1200. The caller module and callee module access different linear memories (e.g., 1030 and 1040).

Initially, before the callee module is invoked, the runtime creates a source buffer (e.g., source buffer 1032) in the caller module's memory (e.g., linear memory 1030). The source buffer contains data to be copied to the callee module's destination buffer (e.g., destination buffer 1042) and is sized to allow data resulting from the callee module's execution to be copied into the source buffer from the destination buffer.

At 1202, the caller module invokes the callee module to run on the same device (e.g., 1060), or on a different device in the same hardware platform (e.g., 1050). In some scenarios, the caller and callee modules are compiled from higher level software languages (e.g., C, C++, Python, Go, Rust, etc.) into WASM binary code. In this example, WebAssembly interface types could be used to pass data from the caller module to the callee module to convert data being passed to the language-native type of the callee, and vice versa, as previously discussed herein (e.g., with reference to FIGS. 3 and 10).

At 1204, the runtime copies data from the source buffer (e.g., 1032) of the caller module to the destination buffer (e.g., 1042) of the callee module. Data is copied to the destination buffer, which can be defined by a component interface for the callee module. The source data is obtained (e.g., by the runtime) using a pointer to the source buffer that is provided by the caller module. In one example, the caller and callee modules may be compiled from the same (or different) software languages into WASM binary code. In this case copying data from the source buffer to the destination buffer can involve converting the source data from the native type of a first software language compiled to the caller module, to intermediate data having an interface type (e.g., WASM interface type), and then converting the intermediate data to destination data having a native type of a second software language compiled to the callee module. The runtime can then populate the destination buffer (e.g., 1042) in the callee module's memory with the destination data, which corresponds to the source data in the source buffer.

The destination buffer may also include a write-back flag or other appropriate indicator. The write-back flag may be initialized in one state (e.g., ‘0’), and set to another state (e.g., ‘1’) when the destination buffer is modified by the callee module. When the write-back flag is set, this indicates that the destination buffer was modified during the callee module's execution and therefore, is to be copied to the source buffer when the callee module completes execution. Once the destination buffer is created, the callee runtime may provide, to the callee module, an offset to the destination buffer within the callee module's memory.

At 1208, a memory tag having a first value, which is referred to herein as an ‘allocation tag,’ is assigned to granules in the destination buffer. Thus, each granule is tagged (e.g., marked) with the allocation tag. Tagging the granules can include storing the allocation tag for each granule in a tag table associated with the offloaded function. The allocation tag (e.g., representing the color blue) indicates that the tagged granule is allocated but not modified during the callee module's execution. The granule may span one or more memory addresses in the destination buffer. In at least one embodiment, the allocation tag is assigned to every granule in the destination buffer.

At 1210, a pointer for the destination buffer (e.g., 1032) is generated. The pointer may be encoded with a pointer tag having a second value and at least a portion of a base address of the destination buffer. The pointer can be used to range within the destination buffer via a modifiable offset in the pointer. Depending on the implementation, the pointer may be encoded with other metadata or information. It should be appreciated that any number of pointer encodings may be used in one or more embodiments including, but not necessarily limited to cryptographically encoded pointers. In a cryptographically encoded pointer, some portion of the pointer is encrypted (e.g., upper/fixed/base address bits, pointer tag, other metadata, etc., or any combination thereof). The contents of the memory referenced by a cryptographically encoded pointer may be encrypted based on a cryptographic algorithm (e.g., tweakable block cipher, etc.) that uses a tweak (or other input) derived, at least in part, from the cryptographically encoded pointer. The tweak may include some or all of the encrypted portion of the pointer, decrypted portion of the pointer, unencrypted portion of the pointer, other metadata or information not contained in the pointer, or any suitable combination thereof.

At 1212, the callee module is executed. The callee module may be, for example, higher level code of a different software language (e.g., C, C++, Python, Go, Rust, etc.) compiled to WASM binary code. Memory accesses by the callee module are directed to the destination buffer in the callee's memory using the pointer encoded with the pointer tag and an offset to the target data in the buffer.

During the execution of the callee, accesses to memory may result in a tag mismatch if data in the destination buffer is modified. In this scenario, at 1214, trap handling can be performed to change the write-back flag for the destination buffer and to update the pointer tag in the pointer. Additional details related to 1214 are shown and described with reference to FIG. 14.

At 1216, once the callee module completes execution, the write-back flag of the destination buffer can be used to determine whether the destination buffer needs to be copied to the source buffer. Additional details related to 1216 are shown and described with reference to FIG. 16.

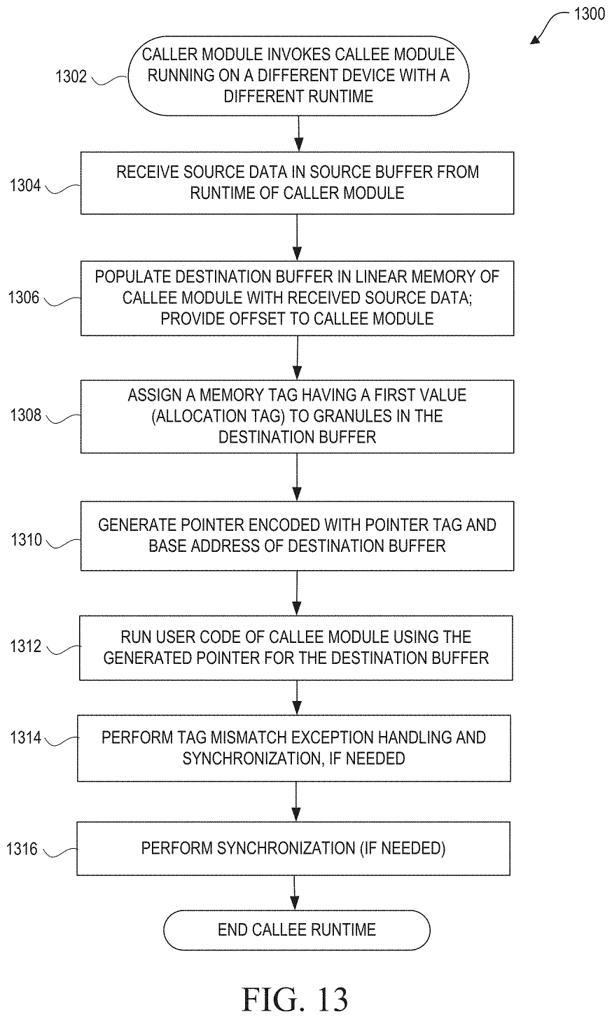

FIG. 13 is a flow diagram of an example process 1300 of possible operations for preparing memory tagging and tracking for a callee module invoked by a caller module, according to at least one embodiment. FIG. 11 illustrates one possible architecture in which the process 1300 may be implemented. In this example, the caller module (e.g., caller WASM module 1112) and the callee module (e.g., callee WASM module 1122) are running on different devices (e.g., stack based VM 1114 on processor 1160, stack based VM 1124 on processor 1180) with different runtimes (e.g., caller WASM runtime 1110, callee WASM runtime 1120). In at least some implementations, the runtime associated with the callee module may be configured with buffer tagging code (e.g., 1126), a trap handler (e.g., 1127), and/or synchronization code (e.g., 1128) to perform at least some of the operations of process 1300. The caller module and callee module access different linear memories (e.g., linear memories 1130 and 1140). Before the callee module is invoked, the caller runtime creates a source buffer (e.g., 1132) in the caller module's memory (e.g., 1130) containing data to be passed to the callee module and sized to allow resulting data to be returned from the callee module.

Initially, before the callee module is invoked, the caller runtime (e.g., 1110) creates a source buffer (e.g., source buffer 1132) in the caller module's memory (e.g., 1130). The source buffer contains data to be copied to the callee module's destination buffer (e.g., destination buffer 1142) and is sized to allow data resulting from the callee module's execution to be copied into the source buffer from the destination buffer.

At 1302, the caller module running on the first device invokes the callee module to run on the second, different device. At 1304, the callee runtime (e.g., callee WASM runtime 1120) receives from the caller runtime (e.g., 1110) data corresponding to the source buffer (e.g., 1132). The data may be provided in an appropriate interface type to enable the conversion of the interface type to the language-native type of the callee module.

As previously described herein, e.g., with reference to FIG. 12, the caller and callee modules may be compiled from higher level source software language into WASM binary code. An interface type is used to convert data of the language-native type of a caller WASM module to the language-native type of a callee WASM module, and vice versa. At 1306, the callee runtime populates a destination buffer (e.g., 1142) of the callee module's memory with the source data converted to the appropriate language-native type of the callee module. In one or more embodiments, the destination buffer is defined by a component interface for the callee module and includes a write-back flag or other appropriate indicator, as previously described herein for example with reference to 1204 of FIG. 12. Once the destination buffer is created, the callee runtime may provide an offset to the callee module.

At 1308, a memory tag having a first value (e.g., the ‘allocation tag’) is assigned to granules in the destination buffer, as previously described herein (e.g., 1208 of FIG. 12). Each granule in the destination buffer can be tagged with the allocation tag, which indicates that the tagged granule is allocated but not modified during the callee module's execution.

At 1310, a pointer for the destination buffer (e.g., 1142) is generated. The pointer may be encoded with a pointer tag having a second value and at least a portion of a base address of the destination buffer, as previously described herein (e.g., 1210 of FIG. 12). The pointer can be used to range within the destination buffer via a modifiable offset in the pointer.

At 1310, the callee module is executed. The callee module may be, for example, higher level code of a different software language (e.g., C, C++, Python, Go, Rust, etc.) compiled to WASM binary code. Memory accesses by the callee module are directed to the destination buffer in the callee's memory using the pointer encoded with the pointer tag and an offset to the target data in the buffer.

During the execution of the callee module, accesses to memory may result in a tag mismatch. In this scenario, if the data in the destination module has been modified, at 1312, trap handling can be performed to change the write-back flag for the destination buffer and to update the pointer tag in the pointer. Additional details related to 1312 are shown and described with reference to FIG. 14.

At 1314, once the callee module completes execution, the write-back flag of the destination buffer can be used to determine whether the destination buffer needs to be sent to the caller module to update the source buffer. Additional details related to 1314 are shown and described with reference to FIG. 16.

FIG. 14 is a flow diagram of an example process 1400 of possible operations for handling an exception based on a tag check failure in a callee module according to at least one embodiment. Process 1400 includes one or more operations related to memory accesses occurring during the execution of a callee module (e.g., callee WASM module 1022, 1122). In some implementations, the runtime associated with the callee module may be configured with a trap handler (e.g., 1027, 1127) to perform at least some of the operations. In other implementations trap handler code may be separate from the runtime and invoked as needed by the runtime or other code.

At 1402, a memory access operation (e.g., read, write, store, move, etc.) at a target address in the destination buffer causes a tag mismatch to occur in hardware. For example, upon reading the target address, tag checking logic (e.g., 136, 1056, 1156) may retrieve a memory tag associated with the target address from a tag table and compare the retrieved memory tag to the pointer tag in the pointer to the target address. If the tags do not match, this indicates that the allocation tag is still associated with the target address as the target address has not yet been modified during the function execution. If the tags do match, this indicates that the destination buffer has already been modified and that the write-back flag has already been set for the destination buffer.

The trap handler (e.g., 1027, 1127) in this embodiment does not cause the execution of the callee module to terminate (or abnormally end) when an exception occurs. Instead, the exception triggers a determination as to whether the destination buffer has been modified during the execution of the callee module. Operations that are performed when an exception occurs are further detailed in process 1400.

At 1404, the runtime detects an exception raised in response to a tag check failure for a memory access operation at a target address in the destination buffer. In at least one embodiment, a tag check failure is a determination that a pointer tag in a pointer used to access a target address in the destination buffer does not match (or otherwise correspond to) a memory tag assigned to a granule associated with the target address.

At 1406, a determination is made as to whether the memory access operation modified data (also referred to as ‘target data’)_stored at the target address. For example, if the memory access was a write operation, then the data at the target address is presumed to have been modified by the callee module. If the memory access was a read operation, then the data at the target address was not modified by the callee module.

If a determination is made that the destination buffer was modified based on the performed memory access operation (e.g., a write operation), this indicates that the source buffer needs to be updated when the callee module returns control to the caller module. In this scenario, the tag in the tag table may be the allocation tag that was used to initialize the granule associated with the target address when the destination buffer was populated with data from the source buffer. Accordingly, at 1408, the pointer tag that is encoded in the pointer is replaced with the allocation tag from the tag table. This prevents future access to the same target address from causing a tag mismatch and another exception to be raised.

At 1410, an indication is provided that the destination buffer was modified during the execution of the callee module. The indication can be provided using any suitable technique. In one example, a write-back flag is set on the destination buffer. The write-back flag can be set (e.g., given a particular value such as ‘1’) to indicate that the destination buffer was modified during the callee module's execution and therefore, the source buffer should be updated when the callee module returns control to the caller module. Conversely, the write-bag flag not being set (e.g., given a particular value such as ‘0’) can indicate that the destination buffer was not modified during the callee module's execution and therefore, the source buffer does not need to be updated when the callee module returns control to the caller module.

At 1406, if a determination is made that the memory access operation did not modify the target address in the destination buffer (e.g., a read operation), this indicates that the tag table contains a tag assigned to the target address that matches the pointer tag encoded in the pointer for the target address. In this scenario, the flow may end without updating the pointer tag in the pointer and without setting the write-back flag.

As previously described herein, instead of using a write-back flag and updating the pointer tag, other embodiments may use memory tagging and tracking as previously described herein with reference to at least FIGS. 4-9.

FIG. 15 is a flow diagram of an example process 1500 of possible operations for synchronizing a destination buffer of a callee module to a source buffer of a caller module according to at least one embodiment.

Process 1500 includes one or more operations occurring once the callee module has finished executing. At 1502, the callee module finishes executing. At 1504, a determination is made as to whether the source buffer needs to be synchronized with (e.g., updated by) the destination buffer. This determination can be made based on the indication provided by the trap handler. For example, if the trap handler provides an indication that the destination buffer was modified during the execution of the callee module, then a determination is made to update the source buffer with the modified destination buffer. If the trap handler provides an indication that the destination buffer was not modified during the execution of the callee module, then a determination is made not to update the source buffer. In one example, the indication provided by the trap handler can be a write-back flag associated with the destination buffer. If the write-back flag is not set (e.g., ‘0’), this indicates that no data in the destination buffer was modified during the callee module execution, and the flow can end.

Alternatively, if the write-back flag is set (e.g., ‘1’), this indicates that the destination buffer was modified during the execution of the callee module and therefore, that the source buffer needs to be synchronized with the destination buffer. In this scenario, at 1506, if the callee module shares a runtime with the caller module, then the runtime can copy the data in destination buffer (or modified portions thereof) to the source buffer. If the callee module and the caller module have different runtimes, however, then the data in the destination buffer (or modified portions thereof) can be returned to caller module and the caller module's runtime can appropriately update the source buffer with the received data.

Some implementations may involve the caller module compiled from a first software language to WASM binary code and the callee module compiled from a second software language to WASM binary code. In this scenario, the destination buffer data can be converted from a native type of the second software language into intermediate data having an interface type. The intermediate data can be converted from the interface type to source data having a native type of the first software language. The runtime, the WASM modules, a dedicated hardware device, and/or separate software module may perform the conversions of the data. The source data having the native type of the first software language can be stored in the source buffer by the runtime that manages the caller WASM module.

The systems and methods described herein can be implemented in or performed by any of a variety of computing systems, including mobile computing systems (e.g., smartphones, handheld computers, tablet computers, laptop computers, portable gaming consoles, 2-in-1 convertible computers, portable all-in-one computers), non-mobile computing systems (e.g., desktop computers, servers, workstations, stationary gaming consoles, set-top boxes, smart televisions, rack-level computing solutions (e.g., blade, tray, or sled computing systems)), and embedded computing systems (e.g., computing systems that are part of a vehicle, smart home appliance, consumer electronics product or equipment, manufacturing equipment).

As used herein, the term “computing system” includes compute nodes, computing devices, and systems comprising multiple discrete physical components. In some embodiments, the computing systems are located in a data center, such as an enterprise data center (e.g., a data center owned and operated by a company and typically located on company premises), managed services data center (e.g., a data center managed by a third party on behalf of a company), a co-located data center (e.g., a data center in which data center infrastructure is provided by the data center host and a company provides and manages their own data center components (servers, etc.)), cloud data center (e.g., a data center operated by a cloud services provider that host companies applications and data), and an edge data center (e.g., a data center, typically having a smaller footprint than other data center types, located close to the geographic area that it serves).

In the simplified example depicted in FIG. 16, a compute node 1600 includes a compute engine (referred to herein as “compute circuitry”) 1602, an input/output (I/O) subsystem 1608, data storage 1610, a communication circuitry subsystem 1612, and, optionally, one or more peripheral devices 1614. With respect to the present example, the compute node 1600 or compute circuitry 1602 may perform the operations and tasks attributed to the host 104 and other computing systems 400, 500, 1000, and 1100 described herein. In other examples, respective compute nodes 1600 may include other or additional components, such as those typically found in a computer (e.g., a display, peripheral devices, etc.). Additionally, in some examples, one or more of the illustrative components may be incorporated in, or otherwise form a portion of, another component.

In some examples, the compute node 1600 may be embodied as a single device such as an integrated circuit, an embedded system, a field-programmable gate array (FPGA), a system-on-a-chip (SOC), or other integrated system or device. In the illustrative example, the compute node 1600 includes or is embodied as a processor 1604 and a memory 1606. The processor 1604 may be embodied as any type of processor capable of performing the functions described herein (e.g., executing compile functions, executing an application, executing WASM modules and components, executing kernel functions, etc.). For example, the processor 1604 may be embodied as a multi-core processor(s), a microcontroller, a processing unit, a specialized or special purpose processing unit, an accelerator, other processor or processing/controlling circuit, or any suitable combination thereof.

In some examples, the processor 1604 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 1604 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs, VPUs, or programmed FPGAs). Such an xPU may be designed to receive programming to process one or more data streams and perform specific tasks and actions for the data streams (such as hosting microservices, performing service management or orchestration, organizing, or managing server or data center hardware, managing service meshes, or collecting and distributing telemetry), outside of the CPU or general-purpose processing hardware. However, it will be understood that a xPU, a SOC, a CPU, and other variations of the processor 1604 may work in coordination with each other to execute many types of operations and instructions within and on behalf of the compute node 1600.

The memory 1606 may be embodied as any type of volatile (e.g., dynamic random-access memory (DRAM), etc.) or non-volatile memory or data storage capable of performing the functions described herein. Volatile memory may be a storage medium that requires power to maintain the state of data stored by the medium. Non-limiting examples of volatile memory may include various types of random-access memory (RAM), such as DRAM or static random-access memory (SRAM). One particular type of DRAM that may be used in a memory module is synchronous dynamic random-access memory (SDRAM).

In an example, the memory device is a block addressable memory device, such as those based on NAND or NOR technologies. A memory device may also include a three-dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, the memory may be embodied as unified memory. In some examples, all or a portion of the memory 1606 may be integrated into the processor 1604. The memory 1606 may store various software and data used during operation such as one or more applications, data operated on by the application(s), libraries, and drivers.

The compute circuitry 1602 is communicatively coupled to other components of the compute node 1600 via the I/O subsystem 1608, which may be embodied as circuitry and/or components to facilitate input/output operations with the compute circuitry 1602 (e.g., with the processor 1604 and/or the main memory 1606) and other components of the compute circuitry 1602. For example, the I/O subsystem 1608 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1608 may form a portion of a system-on-a-chip (SoC) and be incorporated, along with one or more of the processor 1604, the memory 1606, and other components of the compute circuitry 1602, into the compute circuitry 1602.

The one or more illustrative data storage devices 1610 may be embodied as any type of devices configured for short-term or long-term storage of data such as, for example, memory devices and circuits, memory cards, hard disk drives, solid-state drives, or other data storage devices. Individual data storage devices 1610 may include a system partition that stores data and firmware code for the data storage device 1610. Individual data storage devices 1610 may also include one or more operating system partitions that store data files and executables for operating systems depending on, for example, the type of compute node 1600.

The communication circuitry 1612 may be embodied as any communication circuit, device, transceiver circuit, or collection thereof, capable of enabling communications over a network between the compute circuitry 1602 and another compute device (e.g., an edge gateway of an implementing edge computing system).

The communication subsystem 1612 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1612 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication subsystem 1612 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication subsystem 1612 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication subsystem 1612 may operate in accordance with other wireless protocols in other embodiments. The electrical device 1600 may include an antenna 1622 to facilitate wireless communications and/or to receive other wireless communications (such as AM or FM radio transmissions).

In some embodiments, the communication subsystem 1612 may manage wired communications, such as electrical, optical, or any other suitable communication protocols (e.g., IEEE 802.3 Ethernet standards). As noted above, the communication component 1612 may include multiple communication components. For instance, a first communication subsystem 1612 may be dedicated to shorter-range wireless communications such as Wi-Fi or Bluetooth, and a second communication subsystem 1612 may be dedicated to longer-range wireless communications such as global positioning system (GPS), EDGE, GPRS, CDMA, WiMAX, LTE, EV-DO, or others. In some embodiments, a first communication subsystem 1612 may be dedicated to wireless communications, and a second communication subsystem 1612 may be dedicated to wired communications.

The illustrative communication subsystem 1612 includes an optional network interface controller (NIC) 1620, which may also be referred to as a host fabric interface (HFI). The NIC 1620 may be embodied as one or more add-in-boards, daughter cards, network interface cards, controller chips, chipsets, or other devices that may be used by the compute node 1600 to connect with another compute device (e.g., an edge gateway node). In some examples, the NIC 1620 may be embodied as part of a system-on-a-chip (SoC) that includes one or more processors or included on a multichip package that also contains one or more processors. In some examples, the NIC 1620 may include a local processor (not shown) and/or a local memory (not shown) that are both local to the NIC 1620. In such examples, the local processor of the NIC 1620 may be capable of performing one or more of the functions of the compute circuitry 1602 described herein. Additionally, or alternatively, in such examples, the local memory of the NIC 1620 may be integrated into one or more components of the client compute node at the board level, socket level, chip level, and/or other levels.

Additionally, in some examples, a respective compute node 1600 may include one or more peripheral devices 1614. Such peripheral devices 1614 may include any type of peripheral device found in a compute device or server such as audio input devices, a display, other input/output devices, interface devices, and/or other peripheral devices, depending on the particular type of the compute node 1600. In further examples, the compute node 1600 may be embodied by a respective edge compute node (whether a client, gateway, or aggregation node) in an edge computing system or like forms of appliances, computers, subsystems, circuitry, or other components.

In other examples, the compute node 1600 may be embodied as any type of device or collection of devices capable of performing various compute functions. Respective compute nodes 1600 may be embodied as a type of device, appliance, computer, or other “thing” capable of communicating with other compute nodes that may be edge, networking, or endpoint components. For example, a compute device may be embodied as a personal computer, server, smartphone, a mobile compute device, a smart appliance, smart camera, an in-vehicle compute system (e.g., a navigation system), a weatherproof or weather-sealed computing appliance, a self-contained device within an outer case, shell, etc., or other device or system capable of performing the described functions.

FIG. 17 illustrates a multi-processor environment in which embodiments may be implemented. For example, host 104 and computing systems 400, 500, 1000, and 1100 may be implemented using the multi-processor environment of FIG. 17. Processor units 1702 and 1704 further comprise cache memories 1712 and 1714, respectively. The cache memories 1712 and 1714 can store data (e.g., instructions) utilized by one or more components of the processor units 1702 and 1704, such as the processor cores 1708 and 1710. The cache memories 1712 and 1714 can be part of a memory hierarchy for the computing system 1700. For example, the cache memories 1712 can locally store data that is also stored in a memory 1716 to allow for faster access to the data by the processor unit 1702. In some embodiments, the cache memories 1712 and 1714 can comprise multiple cache levels, such as level 1 (L1), level 2 (L2), level 3 (L3), level 4 (L4) and/or other caches or cache levels. In some embodiments, one or more levels of cache memory (e.g., L2, L3, L4) can be shared among multiple cores in a processor unit or among multiple processor units in an integrated circuit component. In some embodiments, the last level of cache memory on an integrated circuit component can be referred to as a last level cache (LLC). One or more of the higher levels of cache levels (the smaller and faster caches) in the memory hierarchy can be located on the same integrated circuit die as a processor core and one or more of the lower cache levels (the larger and slower caches) can be located on an integrated circuit dies that are physically separate from the processor core integrated circuit dies.

Although the computing system 1700 is shown with two processor units, the computing system 1700 can comprise any number of processor units. Further, a processor unit can comprise any number of processor cores. A processor unit can take various forms such as a central processing unit (CPU), a graphics processing unit (GPU), general-purpose GPU (GPGPU), accelerated processing unit (APU), field-programmable gate array (FPGA), neural network processing unit (NPU), data processor unit (DPU), accelerator (e.g., graphics accelerator, digital signal processor (DSP), compression accelerator, artificial intelligence (AI) accelerator), controller, or other types of processing units. As such, the processor unit can be referred to as an XPU (or xPU). Further, a processor unit can comprise one or more of these various types of processing units. In some embodiments, the computing system comprises one processor unit with multiple cores, and in other embodiments, the computing system comprises a single processor unit with a single core. As used herein, the terms “processor unit” and “processing unit” can refer to any processor, processor core, component, module, engine, circuitry, or any other processing element described or referenced herein.

In some embodiments, the computing system 1700 can comprise one or more processor units that are heterogeneous or asymmetric to another processor unit in the computing system. There can be a variety of differences between the processing units in a system in terms of a spectrum of metrics of merit including architectural, microarchitectural, thermal, power consumption characteristics, and the like. These differences can effectively manifest themselves as asymmetry and heterogeneity among the processor units in a system.

The processor units 1702 and 1704 can be located in a single integrated circuit component (such as a multi-chip package (MCP) or multi-chip module (MCM)) or they can be located in separate integrated circuit components. An integrated circuit component comprising one or more processor units can comprise additional components, such as embedded DRAM, stacked high bandwidth memory (HBM), shared cache memories (e.g., L3, L4, LLC), input/output (I/O) controllers, or memory controllers. Any of the additional components can be located on the same integrated circuit die as a processor unit, or on one or more integrated circuit dies separate from the integrated circuit dies comprising the processor units. In some embodiments, these separate integrated circuit dies can be referred to as “chiplets”. In some embodiments where there is heterogeneity or asymmetry among processor units in a computing system, the heterogeneity or asymmetric can be among processor units located in the same integrated circuit component. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Processor units 1702 and 1704 further comprise memory controller logic (MC) 1720 and 1722. As shown in FIG. 17, MCs 1720 and 1722 control memories 1716 and 1718 coupled to the processor units 1702 and 1704, respectively. The memories 1716 and 1718 can comprise various types of volatile memory (e.g., dynamic random-access memory (DRAM), static random-access memory (SRAM)) and/or non-volatile memory (e.g., flash memory, chalcogenide-based phase-change non-volatile memories), and comprise one or more layers of the memory hierarchy of the computing system. While MCs 1720 and 1722 are illustrated as being integrated into the processor units 1702 and 1704, in alternative embodiments, the MCs can be external to a processor unit.

Processor units 1702 and 1704 are coupled to an Input/Output (I/O) subsystem 1730 via point-to-point interconnections 1732 and 1734. The point-to-point interconnection 1732 connects a point-to-point interface 1736 of the processor unit 1702 with a point-to-point interface 1738 of the I/O subsystem 1730, and the point-to-point interconnection 1734 connects a point-to-point interface 1740 of the processor unit 1704 with a point-to-point interface 1742 of the I/O subsystem 1730. Input/Output subsystem 1730 further includes an interface 1750 to couple the I/O subsystem 1730 to a graphics engine 1752. The I/O subsystem 1730 and the graphics engine 1752 are coupled via a bus 1754.

The Input/Output subsystem 1730 is further coupled to a first bus 1760 via an interface 1762. The first bus 1760 can be a Peripheral Component Interconnect Express (PCIe) bus or any other type of bus. Various I/O devices 1764 can be coupled to the first bus 1760. A bus bridge 1770 can couple the first bus 1760 to a second bus 1780. In some embodiments, the second bus 1780 can be a low pin count (LPC) bus. Various devices can be coupled to the second bus 1780 including, for example, a keyboard/mouse 1782, audio I/O devices 1788, and a storage device 1790, such as a hard disk drive, solid-state drive, or another storage device for storing computer-executable instructions (code) 1792 or data. The code 1792 can comprise computer-executable instructions for performing methods described herein. Additional components that can be coupled to the second bus 1780 include communication device(s) 1784, which can provide for communication between the computing system 1700 and one or more wired or wireless networks 1786 (e.g. Wi-Fi, cellular, or satellite networks) via one or more wired or wireless communication links (e.g., wire, cable, Ethernet connection, radio-frequency (RF) channel, infrared channel, Wi-Fi channel) using one or more communication standards (e.g., IEEE 802.11 standard and its supplements).

In embodiments where the communication devices 1784 support wireless communication, the communication devices 1784 can comprise wireless communication components coupled to one or more antennas to support communication between the computing system 1700 and external devices. The wireless communication components can support various wireless communication protocols and technologies such as Near Field Communication (NFC), IEEE 802.11 (Wi-Fi) variants, WiMax, Bluetooth, Zigbee, 4G Long Term Evolution (LTE), Code Division Multiplexing Access (CDMA), Universal Mobile Telecommunication System (UMTS) and Global System for Mobile Telecommunication (GSM), and 5G broadband cellular technologies. In addition, the wireless modems can support communication with one or more cellular networks for data and voice communications within a single cellular network, between cellular networks, or between the computing system and a public switched telephone network (PSTN).

The system 1700 can comprise removable memory such as flash memory cards (e.g., SD (Secure Digital) cards), memory sticks, Subscriber Identity Module (SIM) cards). The memory in system 1700 (including caches 1712 and 1714, memories 1716 and 1718, and storage device 1790) can store data and/or computer-executable instructions for executing an operating system 1794 and application programs 1796. Example data includes web pages, text messages, images, sound files, and video data biometric thresholds for particular users or other data sets to be sent to and/or received from one or more network servers or other devices by the system 1700 via the one or more wired or wireless networks 1786, or for use by the system 1700. The system 1700 can also have access to external memory or storage (not shown) such as external hard drives or cloud-based storage.

The operating system 1794 (also simplified to “OS” herein) can control the allocation and usage of the components illustrated in FIG. 17 and support the one or more application programs 1796. The application programs 1796 can include common computing system applications (e.g., email applications, calendars, contact managers, web browsers, messaging applications) as well as other computing applications.

In some embodiments, a hypervisor (or virtual machine manager) operates on the operating system 1794 and the application programs 1796 operate within one or more virtual machines operating on the hypervisor. In these embodiments, the hypervisor is a type-2 or hosted hypervisor as it is running on the operating system 1794. In other hypervisor-based embodiments, the hypervisor is a type-1 or “bare-metal” hypervisor that runs directly on the platform resources of the computing system 1794 without an intervening operating system layer.

In some embodiments, the applications 1796 can operate within one or more containers. A container is a running instance of a container image, which is a package of binary images for one or more of the applications 1796 and any libraries, configuration settings, and any other information that one or more applications 1796 need for execution. A container image can conform to any container image format, such as Docker®, Appc, or LXC container image formats. In container-based embodiments, a container runtime engine, such as Docker Engine, LXU, or an open container initiative (OCI)-compatible container runtime (e.g., Railcar, CRI-O) operates on the operating system (or virtual machine monitor) to provide an interface between the containers and the operating system 1794. An orchestrator can be responsible for management of the computing system 1700 and various container-related tasks such as deploying container images to the computing system 1794, monitoring the performance of deployed containers, and monitoring the utilization of the resources of the computing system 1794.

The computing system 1700 can support various additional input devices, represented generally as user interfaces 1798, such as a touchscreen, microphone, monoscopic camera, stereoscopic camera, trackball, touchpad, trackpad, proximity sensor, light sensor, electrocardiogram (ECG) sensor, PPG (photoplethysmogram) sensor, galvanic skin response sensor, and one or more output devices, such as one or more speakers or displays. Other possible input and output devices include piezoelectric and other haptic I/O devices. Any of the input or output devices can be internal to, external to, or removably attachable with the system 1700. External input and output devices can communicate with the system 1700 via wired or wireless connections.

In addition, one or more of the user interfaces 1798 may be natural user interfaces (NUIs). For example, the operating system 1794 or applications 1796 can comprise speech recognition logic as part of a voice user interface that allows a user to operate the system 1700 via voice commands. Further, the computing system 1700 can comprise input devices and logic that allows a user to interact with computing the system 1700 via body, hand or face gestures. For example, a user's hand gestures can be detected and interpreted to provide input to a gaming application.

The I/O devices 1764 can include at least one input/output port comprising physical connectors (e.g., USB, IEEE 1394 (FireWire), Ethernet, RS-232), a power supply (e.g., battery), a global satellite navigation system (GNSS) receiver (e.g., GPS receiver); a gyroscope; an accelerometer; and/or a compass. A GNSS receiver can be coupled to a GNSS antenna. The computing system 1700 can further comprise one or more additional antennas coupled to one or more additional receivers, transmitters, and/or transceivers to enable additional functions.

In addition to those already discussed, integrated circuit components, integrated circuit constituent components, and other components in the computing system 694 can communicate with interconnect technologies such as Intel® QuickPath Interconnect (QPI), Intel® Ultra Path Interconnect (UPI), Computer Express Link (CXL), cache coherent interconnect for accelerators)(CCIX®, serializer/deserializer (SERDES), Nvidia® NVLink, ARM Infinity Link, Gen-Z, or Open Coherent Accelerator Processor Interface (OpenCAPI). Other interconnect technologies may be used and a computing system 1794 may utilize more or more interconnect technologies.

It is to be understood that FIG. 17 illustrates only one example computing system architecture. Computing systems based on alternative architectures can be used to implement technologies described herein. For example, instead of the processors 1702 and 1704 and the graphics engine 1752 being located on discrete integrated circuits, a computing system can comprise an SoC (system-on-a-chip) integrated circuit incorporating multiple processors, a graphics engine, and additional components. Further, a computing system can connect its constituent component via bus or point-to-point configurations different from that shown in FIG. 17. Moreover, the illustrated components in FIG. 17 are not required or all-inclusive, as shown components can be removed and other components added in alternative embodiments.

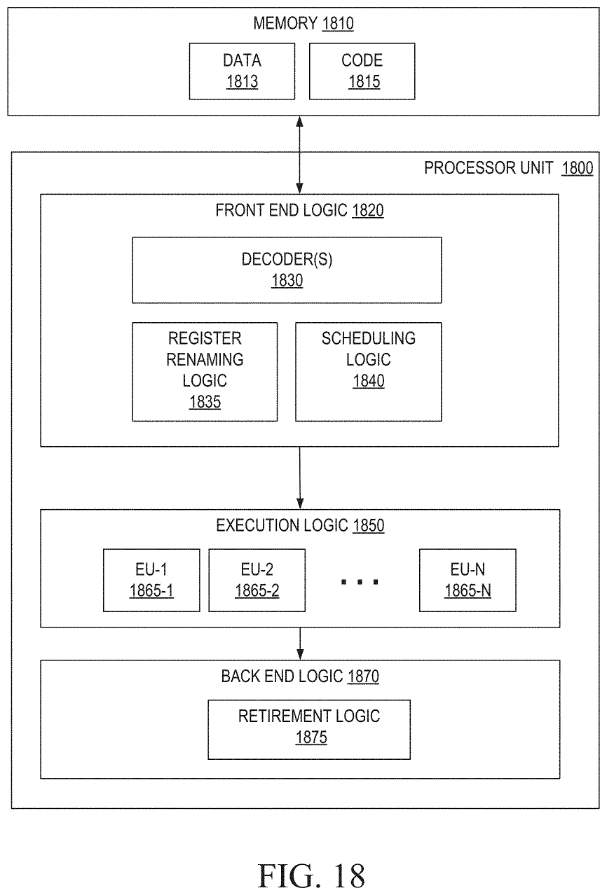

FIG. 18 is a block diagram of an example processor unit 1800 to execute computer-executable instructions as part of implementing technologies described herein. The processor unit 1800 can be a single-threaded core or a multithreaded core in that it may include more than one hardware thread context (or “logical processor” or “logical core”) per processor unit.

FIG. 18 also illustrates a memory 1810 coupled to the processor unit 1800. The memory 1810 can be any memory described herein or any other memory known to those of skill in the art. The memory 1810 can store computer-executable instructions 1815 (code) executable by the processor unit 1800.

The processor unit comprises front-end logic 1820 that receives instructions from the memory 1810. An instruction can be processed by one or more decoders 1830. The decoder 1830 can generate as its output a micro-operation such as a fixed width micro-operation in a predefined format, or generate other instructions, microinstructions, or control signals, which reflect the original code instruction. The front-end logic 1820 further comprises register renaming logic 1835 and scheduling logic 1840, which generally allocate resources and queues operations corresponding to converting an instruction for execution.

The processor unit 1800 further comprises execution logic 1850, which comprises one or more execution units (EUs) 1865-1 through 1865-N. Some processor unit embodiments can include a few execution units dedicated to specific functions or sets of functions. Other embodiments can include only one execution unit or one execution unit that can perform a particular function. The execution logic 1850 performs the operations specified by code instructions. After completion of execution of the operations specified by the code instructions, back-end logic 1870 retires instructions using retirement logic 1875. In some embodiments, the processor unit 1800 allows out of order execution but requires in-order retirement of instructions. Retirement logic 1875 can take a variety of forms as known to those of skill in the art (e.g., re-order buffers or the like).

The processor unit 1800 is transformed during execution of instructions, at least in terms of the output generated by the decoder 1830, hardware registers and tables utilized by the register renaming logic 1835, and any registers (not shown) modified by the execution logic 1850.

Any of the disclosed methods (or a portion thereof) can be implemented as computer-executable instructions (also referred to as machine readable instructions) or a computer program product stored on a computer readable (machine readable) storage medium. Such instructions can cause a computing system or one or more processor units capable of executing computer-executable instructions to perform any of the disclosed methods.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some embodiments, any of the methods herein can be performed by a combination of non-programmable hardware components and one or more processing units executing computer-executable instructions stored on computer-readable storage media.

The computer-executable instructions can be part of, for example, an operating system of the host or computing system, a runtime system including but not limited to WASMTIME, an application, function, component, or module stored locally to the computing system, or a remote application, function, component, or module accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C, assembly language, WebAssembly, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but it is not necessary that every embodiment include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

It should be noted that references herein to particular colors related to tag values are provided for illustration purposes only to distinguish between different tag values. Tag values such as pointer tag values and memory tag values are not limited to representing particular colors or, in fact, any color. Indeed, the tags provided in embodiments disclosed herein may or may not have tag values that are representative of colors.

The following examples pertain to additional embodiments of technologies disclosed herein.

Example C1 provides one or more machine readable storage mediums, including instructions stored therein, and the instructions, when executed by a processor, cause the processor to assign a first tag to a plurality of granules in a first portion of memory allocated for an offloaded function invoked by a module running on a second processor, subsequent to an exception being raised for a tag check failure of a memory access operation in the first portion of the memory, update a modified address list to include information associated with a first memory address, and synchronize, based on the modified address list, a second portion of the memory allocated to the module with the first portion of the memory.

Example C2 comprises the subject matter of Example C1, and the tag check failure is a determination that a second tag encoded in a first pointer to the first memory address associated with the memory access operation does not match the first tag assigned to a first granule of the plurality of granules.

Example C3 comprises the subject matter of Example C2, and the first processor is to execute the instructions further to replace the first tag assigned to the first granule with the second tag encoded in the first pointer at least partly in response to detecting the exception.

Example C4 comprises the subject matter of any one of Examples C2-C3, and the instructions, when executed by the first processor, are to cause the first processor further to, prior to the offloaded function being executed, generate a second pointer encoded with the second tag and a base address corresponding to a beginning of the first portion of the memory.

Example C5 comprises the subject matter of Example C4, and the first pointer is to be generated by modifying a number of bits in the second pointer to represent an offset from the base address to the first memory address.

Example C6 comprises the subject matter of any one of Examples C4-05, and the instructions, when executed by the first processor, are to cause the first processor further to receive the base address of the first portion of the memory from the module.

Example C7 comprises the subject matter of any one of Examples C1-C6, and the first processor is to execute the instructions further to detect the exception for the tag check failure, and the modified address list is to be updated with the information in response to, at least in part, detecting the exception for the tag check failure.

Example C8 comprises the subject matter of Example C7, and the modified address list is to be updated with the information in response to, in part, a determination that the memory access operation modified data stored at the first memory address.

Example C9 comprises the subject matter of any one of Examples C1-C8, and the first portion of the memory is a first continuous range of memory addresses in the memory, and the second portion of the memory is a second continuous range of memory addresses in the memory.

Example C10 comprises the subject matter of any one of Examples C1-C9, and to synchronize the second portion of the memory with the first portion of the memory is to copy data stored at one or more memory addresses specified in the modified address list for the first portion of the memory to one or more corresponding memory addresses in the second portion of the memory.

Example C11 comprises the subject matter of any one of Examples C1-C10, and the information represents the first memory address or an interval of memory addresses that includes the first memory address.

Example C12 comprises the subject matter of any one of Examples C1-C11, and the module includes WebAssembly binary code compiled from a first software language.

Example C13 comprises the subject matter of any one of Examples C1-C12, and the instructions are included in a WebAssembly runtime.

Example C14 comprises the subject matter of any one of Examples C1-C13, and the first processor is a first stack-based virtual processor that runs on a first physical processor, and the second processor is a second stack-based virtual processor that runs on a second physical processor.

Example C15 comprises the subject matter of any one of Examples C1-C14, and the memory is to be mapped to a unified main memory.

Example C16 comprises the subject matter of any one of Examples C1-C15, and the memory is to include a first memory and a second memory that is separate from the first memory, and the first memory is to include the first portion of the memory and the second memory is to include the second portion of the memory.

Example C17 comprises the subject matter of any one of Examples C1-C16, and the memory corresponds to at least one linear memory address space.

Example A1 provides an apparatus including a first processor to be communicatively coupled to a main memory having instructions stored therein, and the first processor is to execute the instructions to assign a first tag to a plurality of granules in a first portion of memory allocated for an offloaded function invoked by a module running on a second processor, detect an exception raised for a tag check failure for a memory access operation in the first portion of the memory, update a modified address list to include information associated with a first memory address, and synchronize, based on the modified address list, a second portion of the memory allocated to the module with the first portion of the memory.

Example A2 comprises the subject matter of Example A1, and the tag check failure is a determination that a second tag encoded in a first pointer to the first memory address associated with the memory access operation does not match the first tag assigned to a first granule of the plurality of granules.

Example A3 comprises the subject matter of Example A2, and the first processor is to execute the instructions further to replace the first tag assigned to the first granule with the second tag encoded in the first pointer at least partly in response to detecting the exception.

Example A4 comprises the subject matter of any one of Examples A2-A3, and the first processor is to execute the instructions further to, prior to the offloaded function being executed, generate a second pointer encoded with the second tag and a base address corresponding to a beginning of the first portion of the memory.

Example A5 comprises the subject matter of Example A4, and the first pointer is to be generated by modifying a number of bits in the second pointer to represent an offset from the base address to the first memory address.

Example A6 comprises the subject matter of any one of Examples A4-A5, and the first processor is to execute the instructions further to receive the base address of the first portion of the memory from the module.

Example A7 comprises the subject matter of any one of Examples A1-A6, and the modified address list is to be updated with the information in response to, at least in part, detecting the exception for the tag check failure.

Example A8 comprises the subject matter of Example A7, and the modified address list is to be updated with the information in response to, in part, a determination that the memory access operation modified data stored at the first memory address.

Example A9 comprises the subject matter of any one of Examples A1-A8, and the first portion of the memory is a first continuous range of memory addresses in the memory, and the second portion of the memory is a second continuous range of memory addresses in the memory.

Example A10 comprises the subject matter of any one of Examples A1-A9, and to synchronize the second portion of the memory with the first portion of the memory is to copy data stored at one or more memory addresses specified in the modified address list for the first portion of the memory to one or more corresponding memory addresses in the second portion of the memory.

Example A11 comprises the subject matter of any one of Examples A1-A10, and the information represents the first memory address or an interval of memory addresses that includes the first memory address.

Example A12 comprises the subject matter of any one of Examples A1-A11, and the module includes WebAssembly binary code compiled from a first software language.

Example A13 comprises the subject matter of any one of Examples A1-A12, and the instructions are included in a WebAssembly runtime.

Example A14 comprises the subject matter of any one of Examples A1-A13, and the first processor is a first stack-based virtual processor that runs on a first physical processor, and the second processor is a second stack-based virtual processor that runs on a second physical processor.

Example A15 comprises the subject matter of any one of Examples A1-A14, and the memory is to be mapped to a unified main memory.

Example A16 comprises the subject matter of any one of Examples A1-A15, and the memory is to include a first memory and a second memory that is separate from the first memory, and the first memory is to include the first portion of the memory and the second memory is to include the second portion of the memory.

Example A17 comprises the subject matter of any one of Examples A1-A16, and the memory corresponds to at least one linear memory address space.

Example M1 provides a method comprising assigning, in a tag table, a first tag to a plurality of granules in a first portion of memory allocated for an offloaded function invoked to a first processor by a module running on a second processor, detecting an exception raised for a tag check failure for a memory access operation in the first portion of the memory, updating a modified address list to include information associated with a first memory address, and synchronizing, based on the modified address list, a second portion of the memory allocated to the module with the first portion of the memory.

Example M2 comprises the subject matter of Example M1, and the tag check failure is a determination that a second tag encoded in a first pointer to a first memory address associated with the memory access operation does not match the first tag assigned to a first granule of the plurality of granules.

Example M3 comprises the subject matter of Example M2, and further comprises replacing the first tag assigned to the first granule with the second tag encoded in the first pointer at least partly in response to detecting the exception.

Example M4 comprises the subject matter of any one of Examples M2-M3, and further comprises prior to the offloaded function being executed, generating a second pointer encoded with the second tag and a base address corresponding to a beginning of the first portion of the memory.

Example M5 comprises the subject matter of Example M4, and further comprises generating the first pointer by modifying a number of bits in the second pointer to represent an offset from the base address to the first memory address.

Example M6 comprises the subject matter of any one of Examples M4-M5, and further comprises receiving the base address of the first portion of the memory from the module.

Example M7 comprises the subject matter of any one of Examples M1-M6, and further comprises updating the modified address list with the information in response to, at least in part, detecting the exception for the tag check failure.

Example M8 comprises the subject matter of Example M7, and further comprises updating the modified address list with the information in response to, in part, a determination that the memory access operation modified data stored at the first memory address.

Example M9 comprises the subject matter of any one of Examples M1-M8, and the first portion of the memory is a first continuous range of memory addresses in the memory, and the second portion of the memory is a second continuous range of memory addresses in the memory.

Example M10 comprises the subject matter of any one of Examples M1-M9, and the synchronizing the second portion of the memory with the first portion of the memory includes copying data stored at one or more memory addresses specified in the modified address list for the first portion of the memory to one or more corresponding memory addresses in the second portion of the memory.

Example M11 comprises the subject matter of any one of Examples M1-M10, and the information represents the first memory address or an interval of memory addresses that includes the first memory address.

Example M12 comprises the subject matter of any one of Examples M1-M11, and the module includes WebAssembly binary code compiled from a first software language.

Example M13 comprises the subject matter of any one of Examples M1-M12, and the offloaded function includes one or more WebAssembly instructions of the WebAssembly binary code of the module.

Example M14 comprises the subject matter of any one of Examples M1-M13, and the first processor is a first stack-based virtual processor that runs on a first physical processor, and the second processor is a second stack-based virtual processor that runs on a second physical processor.

Example M15 comprises the subject matter of any one of Examples M1-M14, and the memory is to be mapped to a unified main memory.

Example M16 comprises the subject matter of any one of Examples M1-M15, and the memory includes a first memory and a second memory that is separate from the first memory, and the first memory includes the first portion of the memory and the second memory includes the second portion of the memory.

Example M17 comprises the subject matter of any one of Examples M1-M16, and the memory corresponds to at least one linear memory address space.

Example S1 provides a system including a main memory to store instructions and a first processor communicatively coupled to the main memory, and the first processor is to execute the instructions to assign an allocation tag having a first value to a plurality of granules in a first portion of memory allocated for an offloaded function invoked by a module running on a second processor of the system, subsequent to an exception being raised for a tag check failure of a memory access operation in the first portion of the memory, update a modified address list to include information associated with a first memory address, and synchronize, based on the modified address list, a second portion of the memory allocated to the module with the first portion of the memory.

Example S2 comprises the subject matter of Example S1, and the tag check failure is a determination that an addressing tag having a second value encoded in a first pointer to the first memory address associated with the memory access operation does not match the allocation tag assigned to a first granule of the plurality of granules.

Example S3 comprises the subject matter of Example S2, and the first processor is to execute the instructions further to replace the allocation tag assigned to the first granule with the addressing tag encoded in the first pointer at least partly in response to detecting the exception.

Example S4 comprises the subject matter of any one of Examples S2-S3, and the first processor is to execute the instructions further to prior to the offloaded function being executed, generate a second pointer encoded with the addressing tag and a base address corresponding to a beginning of the first portion of the memory.

Example S5 comprises the subject matter of Example S4, and the instructions, when executed by the first processor, are to cause the first processor further to generate the first pointer by modifying a number of bits in the second pointer to represent an offset from the base address to the first memory address.

Example S6 comprises the subject matter of any one of Examples S4-S5, and the first processor is to execute the instructions further to receive the base address of the first portion of the memory from the module.

Example S7 comprises the subject matter of any one of Examples S1-S6, and the first processor is to execute the instructions further to detect the exception for the tag check failure, and the modified address list is to be updated with the information in response to, at least in part, detecting the exception for the tag check failure.

Example S8 comprises the subject matter of Example S7, and the modified address list is to be updated with the information in response to, in part, a determination that the memory access operation modified data stored at the first memory address.

Example S9 comprises the subject matter of any one of Examples S1-S8, and the first portion of the memory is a first continuous range of memory addresses in the memory, and the second portion of the memory is a second continuous range of memory addresses in the memory.

Example S10 comprises the subject matter of any one of Examples S1-S9, and to synchronize the second portion of the memory with the first portion of the memory is to copy data stored at one or more memory addresses specified in the modified address list for the first portion of the memory to one or more corresponding memory addresses in the second portion of the memory.

Example S11 comprises the subject matter of any one of Examples S1-S10, and the information represents the first memory address or an interval of memory addresses that includes the first memory address.

Example S12 comprises the subject matter of any one of Examples S1-S11, and the module includes WebAssembly binary code compiled from a first software language.

Example S13 comprises the subject matter of any one of Examples S1-S12, and the instructions are included in a WebAssembly runtime.

Example S14 comprises the subject matter of any one of Examples S1-S13, and the first processor is a first stack-based virtual processor that runs on a first physical processor, and the second processor is a second stack-based virtual processor that runs on a second physical processor.

Example S15 comprises the subject matter of any one of Examples S1-S14, and the memory is to be mapped to a unified main memory.

Example S16 comprises the subject matter of any one of Examples S1-S15, and the memory is to include a first memory and a second memory that is separate from the first memory, and the first memory is to include the first portion of the memory and the second memory is to include the second portion of the memory.

Example S17 comprises the subject matter of any one of Examples S1-S16, and the memory corresponds to at least one linear memory address space.

Example CC1 provides one or more machine readable storage mediums, where the Example of CC1 includes instructions stored therein, and the instructions, when executed by a processor, cause the processor to assign a first tag to a plurality of granules of first data stored in a first buffer in a memory, and the first buffer is to be used by a callee module invoked by a caller module, where the first data corresponds to source data in a second buffer. Example CC1 also includes the instructions, when executed by the processor, cause the processor further to, subsequent to an exception being raised for a tag check failure of a memory access operation based on a first pointer to a first memory address in the first buffer: provide an indication that the first data in the first buffer was modified by the callee module, and replace a second tag encoded in the first pointer with the first tag.

Example CC2 comprises the subject matter of Example CC1, and the tag check failure is a determination that the second tag encoded in the first pointer does not match the first tag assigned to a first granule associated with the first memory address in the first buffer.

Example CC3 comprises the subject matter of Example CC2, and the instructions, when executed by the processor, cause the processor further to determine that the second buffer is to be synchronized with the first buffer based on the indication that the first data in the first buffer was modified by the callee module.

Example CC4 comprises the subject matter of Example CC3, and the instructions, when executed by the processor, cause the processor further to, in response to determining that the second buffer is to be synchronized with the first buffer, either copy current data from the first buffer to the second buffer or send the current data in the first buffer to a runtime of the caller module.

Example CC5 comprises the subject matter of any one of Examples CC1-CC4, and the instructions, when executed by the processor, cause the processor further to prior to the callee module being executed, generate a second pointer encoded with the second tag and a first base address corresponding to a beginning of the first buffer.

Example CC6 comprises the subject matter of Example CC5, and the first pointer is to be generated by modifying a number of bits in the second pointer to represent an offset from the first base address to the first memory address.

Example CC7 comprises the subject matter of any one of Examples CC1-CC6, and the instructions, when executed by the processor, are to cause the processor further to receive, from the callee module, a third pointer including a second base address to the second buffer.

Example CC8 comprises the subject matter of any one of Examples CC1-CC7, and the instructions, when executed by the processor, are to cause the processor further to detect the exception for the tag check failure, and the indication is to be provided in response to, at least in part, detecting the exception for the tag check failure.

Example CC9 comprises the subject matter of any one of Examples CC1-CC8, and the indication is to be provided in response to, in part, a determination that the memory access operation modified at least a portion of the first data stored at the first memory address.

Example CC10 comprises the subject matter of any one of Examples CC1-CC9, and the second buffer and the first buffer are stored in different memories.

Example CC11 comprises the subject matter of any one of Examples CC1-CC10, and to provide the indication that the first buffer was modified by the callee module is to include setting a flag associated with the first buffer.

Example CC12 comprises the subject matter of any one of Examples CC1-CC11, and the callee module is to be compiled from a first software language having a first native type to first WebAssembly binary code, and the caller module is to be compiled from a second software language having a second native type to second WebAssembly binary code.

Example CC13 comprises the subject matter of Example CC12, and the instructions, when executed by the processor, cause the processor further to populate the first buffer with the first data prior to the first tag being assigned to the plurality of granules.

Example CC14 comprises the subject matter of Example CC13, and the instructions, when executed by the processor, cause the processor further to, prior to populating the first buffer with the first data: obtaining the source data using a second pointer to the second buffer, converting the source data having the second native type to second data having an interface type, and converting the second data to the first data having the first native type.

Example CC15 comprises the subject matter of Example CC13, and the instructions, when executed by the processor, cause the processor further to, prior to populating the first buffer with the first data: receiving, from the caller module, second data having an interface type, and converting the second data to the first data, the first data having the first native type of the first software language.

Example CC16 comprises the subject matter of any one of Examples CC1-CC15, and the first data includes a plurality of addressable data portions, and each addressable data portion includes one or more granules not included in other addressable data portions.

Example CC17 comprises the subject matter of any one of Examples CC1-CC16, and the first memory corresponds to a first linear memory address space, and a second memory corresponds to a second linear memory address space containing the second buffer.

Example AA1 provides an apparatus that includes a first processor to be communicatively coupled to a main memory having instructions stored therein, and the first processor is to execute the instructions to assign a first tag to a plurality of granules of first data stored in a destination buffer in a memory, and the destination buffer is to be used by a callee module invoked by a caller module, and the first data corresponds to source data in a source buffer. In Example AA1 the first processor is to execute the instructions further to, subsequent to an exception being raised for a tag check failure of a memory access operation based on a first pointer to a first memory address in the destination buffer: provide an indication that the first data in the destination buffer was modified by the callee module, and replace a second tag encoded in the first pointer with the first tag.

Example AA2 comprises the subject matter of Example AA1, and the tag check failure is a determination that the second tag encoded in the first pointer does not match the first tag assigned to a first granule associated with the first memory address in the destination buffer.

Example AA3 comprises the subject matter of Example AA2, and the first processor is to execute the instructions further to determine that the source buffer is to be synchronized with the destination buffer based on the indication that the first data in the destination buffer was modified by the callee module.

Example AA4 comprises the subject matter of Example AA3, and the first processor is to execute the instructions further to in response to determining that the source buffer is to be synchronized with the destination buffer, either copy current data from the destination buffer to the source buffer or send the current data in the destination buffer to a runtime of the caller module.

Example AA5 comprises the subject matter of any one of Examples AA1-AA4, and the first processor is to execute the instructions further to prior to the callee module being executed, generate a second pointer encoded with the second tag and a first base address corresponding to a beginning of the destination buffer.

Example AA6 comprises the subject matter of Example AA5, and the first pointer is to be generated by modifying a number of bits in the second pointer to represent an offset from the first base address to the first memory address.

Example AA7 comprises the subject matter of any one of Examples AA1-AA6, and the first processor is to execute the instructions further to receive, from the callee module, a third pointer including a second base address to the source buffer.

Example AA8 comprises the subject matter of any one of Examples AA1-AA7, and the first processor is to execute the instructions further to detect the exception for the tag check failure, and the indication is to be provided in response to, at least in part, detecting the exception for the tag check failure.

Example AA9 comprises the subject matter of any one of Examples AA1-AA8, and the indication is to be provided in response to, in part, a determination that the memory access operation modified at least a portion of the first data stored at the first memory address.

Example AA10 comprises the subject matter of any one of Examples AA1-AA9, and the source buffer and the destination buffer are stored in different memories.

Example AA11 comprises the subject matter of any one of Examples AA1-AA10, and to provide the indication that the destination buffer was modified by the callee module is to include setting a flag associated with the destination buffer.

Example AA12 comprises the subject matter of any one of Examples AA1-AA11, and the callee module is to be compiled from a first software language having a first native type to first WebAssembly binary code, and the caller module is to be compiled from a second software language having a second native type to second WebAssembly binary code.

Example AA13 comprises the subject matter of Example AA12, and the first processor is to execute the instructions further to populate the destination buffer with the first data prior to the first tag being assigned to the plurality of granules.

Example AA14 comprises the subject matter of Example AA13, and the first processor is to execute the instructions further to, prior to populating the destination buffer with the first data: obtain the source data using a pointer to the source buffer, convert the source data to an interface type, and convert the interface type to the first data having the first native type of the first software language.

Example AA15 comprises the subject matter of Example AA13, and the first processor is to execute the instructions further to, prior to populating the destination buffer with the first data: receiving, from the caller module, second data having an interface type, and converting the second data to the first data, the first data having the first native type of the first software language.

Example AA16 comprises the subject matter of any one of Examples AA1-AA15, and the first data includes a plurality of addressable data portions, and each addressable data portion includes one or more granules not included in other addressable data portions.

Example AA17 comprises the subject matter of any one of Examples AA1-AA16, and the first memory corresponds to a first linear memory address space, and a second memory corresponds to a second linear memory address space containing the second buffer.

Example MM1 provides a method including assigning a first tag to a plurality of granules of first data stored in a first buffer in a memory, and the first buffer is used by a callee module invoked by a caller module, and the first data corresponds to source data in a second buffer. Example MM1 further includes, subsequent to an exception being raised for a tag check failure of a memory access operation based on a first pointer to a first memory address in the first buffer: providing an indication that the first data in the first buffer was modified by the callee module and replacing a second tag encoded in the first pointer with the first tag.

Example MM2 comprises the subject matter of Example MM1, and the tag check failure is a determination that the second tag encoded in the first pointer does not match the first tag assigned to a first granule associated with the first memory address in the first buffer.

Example MM3 comprises the subject matter of Example MM2, and further comprises determining that the second buffer is to be synchronized with the first buffer based on the indication that the first data in the first buffer was modified by the callee module.

Example MM4 comprises the subject matter of Example MM3, and further comprises, in response to determining that the second buffer is to be synchronized with the first buffer, either copying current data in the first buffer to the second buffer or sending the current data in the first buffer to a runtime of the caller module.

Example MM5 comprises the subject matter of any one of Examples MM1-MM4, and further comprises, prior to the callee module being executed, generating a second pointer encoded with the second tag and a first base address corresponding to a beginning of the first buffer.

Example MM6 comprises the subject matter of Example MM5, and the first pointer is generated by modifying a number of bits in the second pointer to represent an offset from the first base address to the first memory address.

Example MM7 comprises the subject matter of any one of Examples MM1-MM6, and further comprises receiving, from the callee module, a third pointer including a second base address to the second buffer.

Example MM8 comprises the subject matter of any one of Examples MM1-MM7, and further comprises detecting the exception for the tag check failure, and the indication is provided in response to, at least in part, detecting the exception for the tag check failure.

Example MM9 comprises the subject matter of any one of Examples MM1-MM8, and the indication is provided in response to, in part, a determination that the memory access operation modified at least a portion of the first data stored at the first memory address.

Example MM10 comprises the subject matter of any one of Examples MM1-MM9, and the second buffer and the first buffer are stored in different memories.

Example MM11 comprises the subject matter of any one of Examples MM1-MM10, and the providing the indication that the first buffer was modified by the callee module includes setting a flag associated with the first buffer.

Example MM12 comprises the subject matter of any one of Examples MM1-MM11, and the callee module is compiled from a first software language having a first native type to first WebAssembly binary code, and the caller module is compiled from a second software language having a second native type to second WebAssembly binary code.

Example MM13 comprises the subject matter of Example MM12, and further comprises populating the first buffer with the first data prior to the assigning the first tag to the plurality of granules.

Example MM14 comprises the subject matter of Example MM13, and further comprises, prior to the populating the first buffer with the first data: obtaining the source data using a second pointer to the second buffer, converting the source data having the second native type to second data having an interface type, and converting the second data to the first data having the first native type.

Example MM15 comprises the subject matter of Example MM13, and further comprises, prior to the populating the first buffer with the first data: receiving, from the caller module, second data having an interface type and converting the second data to the first data, the first data having the first native type of the first software language.

Example MM16 comprises the subject matter of any one of Examples MM1-MM15, and the first data includes a plurality of addressable data portions, and each addressable data portion includes one or more granules not included in other addressable data portions.

Example MM17 comprises the subject matter of any one of Examples MM1-MM16, and the first memory corresponds to a first linear memory address space, and a second memory corresponds to a second linear memory address space containing the second buffer.

Example SS1 provides a system including a memory circuitry to store runtime instructions and a processor to be communicatively coupled to the memory circuitry, and the processor is to execute the runtime instructions to assign a first tag to a plurality of granules of first data stored in a destination buffer in a memory, and the destination buffer is to be used by a callee module invoked by a caller module, and the first data corresponds to source data in a source buffer. Example SS1 includes the processor is to execute the runtime instructions further to, subsequent to an exception being raised for a tag check failure of a memory access operation based on a first pointer to a first memory address in the destination buffer: provide an indication that the first data in the destination buffer was modified by the callee module and replace a second tag encoded in the first pointer with the first tag.

Example SS2 comprises the subject matter of Example SS1, and the tag check failure is a determination that the second tag encoded in the first pointer does not match the first tag assigned to a first granule associated with the first memory address in the destination buffer.

Example SS3 comprises the subject matter of Example SS2, and the processor is to execute the runtime instructions further to determine that the source buffer is to be synchronized with the destination buffer based on the indication that the first data in the destination buffer was modified by the callee module.

Example SS4 comprises the subject matter of Example SS3, and the processor is to execute the runtime instructions further to in response to determining that the source buffer is to be synchronized with the destination buffer, either copy current data from the destination buffer to the source buffer or send the current data in the destination buffer to a runtime of the caller module.

Example SS5 comprises the subject matter of any one of Examples SS1-SS4, and the processor is to execute the runtime instructions further to, prior to the callee module being executed, generate a second pointer encoded with the second tag and a first base address corresponding to a beginning of the destination buffer.

Example SS6 comprises the subject matter of Example SS5, and the first pointer is to be generated by modifying a number of bits in the second pointer to represent an offset from the first base address to the first memory address.

Example SS7 comprises the subject matter of any one of Examples SS1-SS6, and the processor is to execute the runtime instructions further to receive, from the callee module, a third pointer including a second base address to the source buffer.

Example SS8 comprises the subject matter of any one of Examples SS1-SS7, and the processor is to execute the runtime instructions further to detect the exception for the tag check failure, and the indication is to be provided in response to, at least in part, detecting the exception for the tag check failure.

Example SS9 comprises the subject matter of any one of Examples SS1-SS8, and the indication is to be provided in response to, in part, a determination that the memory access operation modified at least a portion of the first data stored at the first memory address.

Example SS10 comprises the subject matter of any one of Examples SS1-SS9, and the source buffer and the destination buffer are stored in different memories.

Example SS11 comprises the subject matter of any one of Examples SS1-SS10, and to provide the indication that the destination buffer was modified by the callee module is to include setting a flag associated with the destination buffer.

Example SS12 comprises the subject matter of any one of Examples SS1-SS11, and the callee module is to be compiled from a first software language having a first native type to first WebAssembly binary code, and the caller module is to be compiled from a second software language having a second native type to second WebAssembly binary code.

Example SS13 comprises the subject matter of Example SS12, and the processor is to execute the runtime instructions further to, prior to the first tag being assigned to the plurality of granules of the first data stored in the destination buffer, populate the destination buffer with the first data.

Example SS14 comprises the subject matter of Example SS13, and the processor is to execute the runtime instructions further to, prior to populating the destination buffer with the first data: obtain the source data using a pointer to the source buffer, convert the source data to an interface type, and convert the interface type to the first data having the first native type of the first software language.

Example SS15 comprises the subject matter of Example SS13, and the processor is to execute the runtime instructions further to, prior to populating the destination buffer with the first data: receiving, from the caller module, second data having an interface type, and converting the second data to the first data, the first data having the first native type of the first software language.

Example SS16 comprises the subject matter of any one of Examples SS1-SS15, and the first data includes a plurality of addressable data portions, and each addressable data portion includes one or more granules not included in other addressable data portions.

Example SS17 comprises the subject matter of any one of Examples SS1-SS16, and the first memory corresponds to a first linear memory address space, and a second memory corresponds to a second linear memory address space containing the second buffer.

Example X1 provides an apparatus for comprising means for performing the method of any one of Examples M1-M17 or MM1-MM17.

Example X2 comprises the subject matter of Example X1 can optionally include that the means for performing the method comprises at least one processor and at least one memory element.

Example X3 comprises the subject matter of Example X2 can optionally include that the at least one memory element comprises machine readable instructions that when executed, cause the apparatus to perform the method of any one of Examples M1-M17 or MM1-MM17.

Example X4 comprises the subject matter of any one of Examples X1-X3 can optionally include that the apparatus is one of a computing system, a processing element, or a system-on-a-chip.

Example Y1 provides at least one machine readable storage medium comprising instructions, and the instructions when executed realize an apparatus, realize a system, or implement a method as in any one of the preceding Examples.

1. One or more machine readable media including instructions stored therein, wherein the instructions, when executed by a first processor, cause the first processor to:
assign a first tag to a plurality of granules in a first portion of memory allocated for an offloaded function invoked by a module running on a second processor;
subsequent to an exception being raised for a tag check failure of a memory access operation in the first portion of the memory, update a modified address list to include information associated with a first memory address; and
synchronize, based on the modified address list, a second portion of the memory allocated to the module with the first portion of the memory.

2. The one or more machine readable media of claim 1, wherein the tag check failure is a determination that a second tag encoded in a first pointer to the first memory address associated with the memory access operation does not match the first tag assigned to a first granule of the plurality of granules.

3. The one or more machine readable media of claim 2, wherein the first processor is to execute the instructions further to:
replace the first tag assigned to the first granule with the second tag encoded in the first pointer at least partly in response to detecting the exception.

4. The one or more machine readable media of claim 2, wherein the instructions, when executed by the first processor, are to cause the first processor further to:
prior to the offloaded function being executed, generate a second pointer encoded with the second tag and a base address corresponding to a beginning of the first portion of the memory.

5. The one or more machine readable media of claim 4, wherein the first pointer is to be generated by modifying a number of bits in the second pointer to represent an offset from the base address to the first memory address.

6. The one or more machine readable media of claim 4, wherein the instructions, when executed by the first processor, are to cause the first processor further to:
receive the base address of the first portion of the memory from the module.

7. The one or more machine readable media of claim 1, wherein the first processor is to execute the instructions further to:
detect the exception for the tag check failure, wherein the modified address list is to be updated with the information in response to, at least in part, detecting the exception for the tag check failure.

8. The one or more machine readable media of claim 7, wherein the modified address list is to be updated with the information in response to, in part, a determination that the memory access operation modified data stored at the first memory address.

9. The one or more machine readable media of claim 1, wherein the first portion of the memory is a first continuous range of memory addresses in the memory, wherein the second portion of the memory is a second continuous range of memory addresses in the memory.

10. The one or more machine readable media of claim 1, wherein to synchronize the second portion of the memory with the first portion of the memory is to:
copy data stored at one or more memory addresses specified in the modified address list for the first portion of the memory to one or more corresponding memory addresses in the second portion of the memory.

11. The one or more machine readable media of claim 1, wherein the information represents the first memory address or an interval of memory addresses that includes the first memory address.

12. The one or more machine readable media of claim 1, wherein the module includes WebAssembly binary code compiled from a first software language.

13. The one or more machine readable media of claim 1, wherein the instructions are included in a WebAssembly runtime.

14. The one or more machine readable media of claim 1, wherein the first processor is a first stack-based virtual processor that runs on a first physical processor, and wherein the second processor is a second stack-based virtual processor that runs on a second physical processor.

15. The one or more machine readable media of claim 1, wherein the memory is to be mapped to a unified main memory.

16. An apparatus, comprising:
a first processor to be communicatively coupled to a main memory having instructions stored therein, wherein the first processor is to execute the instructions to:
assign a first tag to a plurality of granules in a first portion of memory allocated for an offloaded function invoked by a module running on a second processor;
detect an exception raised for a tag check failure for a memory access operation in the first portion of the memory;
update a modified address list to include information associated with a first memory address; and
synchronize, based on the modified address list, a second portion of the memory allocated to the module with the first portion of the memory.

17. The apparatus of claim 16, wherein the tag check failure is a determination that a second tag encoded in a first pointer to the first memory address associated with the memory access operation does not match the first tag assigned to a first granule of the plurality of granules.

18. The apparatus of claim 17, wherein the first processor is to execute the instructions further to:
replace the first tag assigned to the first granule with the second tag encoded in the first pointer at least partly in response to detecting the exception.

19. The apparatus of claim 16, wherein the modified address list is to be updated with the information in response to detecting the exception for the tag check failure and a determination that the memory access operation modified data stored at the first memory address.

20. The apparatus of claim 16, wherein the memory includes a first memory and a second memory that is separate from the first memory, wherein the first memory includes the first portion of the memory and the second memory includes the second portion of the memory.

21. A method comprising:
assigning, in a tag table, a first tag to a plurality of granules in a first portion of memory allocated for an offloaded function invoked to a first processor by a module running on a second processor;
detecting an exception raised for a tag check failure for a memory access operation in the first portion of the memory;
updating a modified address list to include information associated with a first memory address; and
synchronizing, based on the modified address list, a second portion of the memory allocated to the module with the first portion of the memory.

22. The method of claim 21, further comprising:
detecting the exception for the tag check failure, wherein the modified address list is updated with the information in response to detecting the exception for the tag check failure and determining that the memory access operation modified data stored at the first memory address.

23. A system, comprising:
a main memory to store instructions; and
a first processor communicatively coupled to the main memory, the first processor to execute the instructions to:
assign an allocation tag having a first value to a plurality of granules in a first portion of memory allocated for an offloaded function invoked by a module running on a second processor of the system;
subsequent to an exception being raised for a tag check failure of a memory access operation in the first portion of the memory, update a modified address list to include information associated with a first memory address; and
synchronize, based on the modified address list, a second portion of the memory allocated to the module with the first portion of the memory.

24. The system of claim 23, wherein the tag check failure is a determination that an addressing tag having a second value encoded in a first pointer to the first memory address associated with the memory access operation does not match the allocation tag assigned to a first granule of the plurality of granules.

25. The system of claim 24, wherein the first processor is to execute the instructions further to:
replace the allocation tag assigned to the first granule with the addressing tag encoded in the first pointer at least partly in response to detecting the exception.
